(19) United States
(12) Patent Application Publication
(10) Pub. No.: US 2009/0073511 A1
(43) Pub. Date: Mar. 19, 2009

(54) METHOD OF AND SYSTEM FOR DRAWING

(75) Inventors: Naoto Kinjo, Kanagawa-ken (JP); Mitsuru Mushano, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/912,227

(22) PCT Filed: Apr. 21, 2006
(86) PCT No.: PCT/JP2006/308927

§ 371 Date: Oct. 22, 2007

(30) Foreign Application Priority Data
Apr. 21, 2005 (JP) 2005-124339

(51) Int. Cl. H04N 1/04

(52) U.S. Cl. 358/497

(57) ABSTRACT

An image is drawn on a substrate (12) by forming imaging spots on the substrate (12) based on the imaging spot data. The imaging spot data is obtained by obtaining vector format image data representing an image, obtaining coordinates of a position on the image data corresponding to a position on the substrate (12), and obtaining the imaging spot data of the imaging spots based on the vector format image data and the coordinates of the position.

### TECHNICAL FIELD

This invention relates to a method of and a system for obtaining imaging spot data for drawing an image on a drawing object by moving an imaging spot region, where imaging spots are formed based on imaging spot data, relative to a drawing object and forming in sequence the imaging spot regions according to the movement of the imaging spot forming region and a method of and a system for drawing an image on a drawing object based on imaging spot data obtained by the method of and a system for obtaining imaging spot data.

### BACKGROUND ART

There have been proposed various exposure systems using a photolithography as a system for drawing a predetermined pattern on a printed circuit board and a substrate of a flat panel display such as a liquid crystal display.

As such an exposure system, there has been proposed one for forming a wiring pattern by causing a light beam to scan in a main scanning direction and a sub-scanning direction a substrate to which photoresist has been applied while the light beam is modulated based on image data representing the wiring pattern.

Further, as an exposure system described above, there has been proposed one where a spatial light modulator element such as a DMD (digital micro mirror device) is employed and a light beam is modulated based on an image data.

As an exposure system employing the DMD, there has been proposed one where a desired image is formed by moving the DMD in a predetermined scanning direction relative to the exposing surface while inputting image data corresponding to the number of micro mirrors in the memory cell of the DMD in response to movement of the DMD in the scanning direction so that spot groups corresponding to the micro mirrors of the DMD are formed in sequence in time sharing. See, for instance, Japanese Unexamined Patent Publication No. 2004-233718.

When an exposure pattern is formed with an exposure system described above, pieces of imaging spot data corresponding to positions of the DMD with respect to the exposing surface are input in sequence into the DMD with the movement of the DMD. The imaging spot data is obtained by converting image data in the vector format to raster form image data in a data making system provided with a CAD station or a CAM (computer aided manufacturing) station and reading out pixel data according to the position of the DMD with respect to the exposing surface from the raster form image data. See, for instance, Japanese Unexamined Patent Publication Nos. 2003-057834 and 2003-050469.

### DISCLOSURE OF THE INVENTION

When the imaging spot data is obtained in the manner described above, if, for instance, the substrate which is to be exposed is deformed, the imaging spot data is obtained with positions of the pixels read out from the raster form image data adjusted according to the deformation of the substrate. However, since the raster form image data is lower than the vector format image data in resolution, accuracy of the line width or the like can be sometimes deteriorated, and when there exists a slant line or the like in the wiring pattern, jaggies can be generated in the slant line, whereby accuracy of exposure can deteriorate.

If the resolution of the raster form image data is increased in order to avoid the problem described above, the amount of data becomes vast and accordingly, calculation of the position of the read-out pixel in the image data requires a long time and/or the image data must be accessed increased times, which leads deterioration of processing speed. Further, it can lead to necessity of increasing capacity of the memory which stores the image data and causes the cost to increase.

In view of the foregoing observations and description, the primary object of the present invention is to provide a method of and a system for obtaining the imaging spot data described above which can increase the accuracy without deteriorating the processing speed or increasing the cost.

Another object of the present invention is to provide a method of and a system for drawing an image by the use of the imaging spot data obtained by the method of and the system for obtaining the imaging spot data described above.

In accordance with a present invention, there is provided a first method of obtaining imaging spot data which is employed to draw an image on a drawing object by forming imaging spots on the drawing object based on the imaging spot data wherein the improvement comprises the steps of: obtaining original vector format image data of the image; obtaining coordinates of a position on the image data corresponding to a position at which the imaging spots should be formed on the drawing object; and obtaining the imaging spot data of the imaging spots based on the vector format image data and the coordinates of the position.

In the first method of obtaining imaging spot data of the present invention, the imaging spot data may be obtained based on image data of an image area to which the coordinates belong by superposing the image area determined based on the image data on the coordinates of the position.

In this case, the imaging spot data may be used to draw an image by moving an imaging spot forming region in which the imaging spots are formed based on the image spot data relative to the drawing object and forming imaging spots in sequence on the drawing object with the movement of the imaging spot forming region, based on the imaging spot data, and the coordinates of the position may correspond to a position of an imaging spot forming region at a predetermined position on the drawing object.

The imaging spot data may be obtained based on image data of an image area determined based on the image data where a line including the coordinates of the position overlaps by superposing the line on the image area.

A configuration may be adopted, wherein: the imaging spot data is obtained, based on the position at which the image data and the line intersect.

A configuration may be adopted, wherein the method of obtaining imaging spot data further comprises the step of: obtaining intersection arrangement data that indicates the intersections between the line and the contour of an image, represented by the image data or derivable from the image data; and wherein: the imaging spot data is obtained, based on the intersection arrangement data.

A configuration may be adopted, wherein: the line connects a plurality of the positional coordinates that correspond to a plurality of the imaging spots.

A configuration may be adopted, wherein: the line connects a plurality of the positional coordinates that correspond to a plurality of the imaging spots, arranged in order of temporal series.

A configuration may be adopted, wherein: the imaging spot data is used to draw an image by moving an imaging spot forming region in which the imaging spots are formed based on the image spot data relative to the drawing object and forming imaging spots in sequence on the drawing object with the movement of the imaging spot forming region, based on the imaging spot data; and the line connects a plurality of the positional coordinates that correspond to a plurality of the imaging spots, arranged in order of temporal series.

The imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the line may correspond to an imaging locus (or trajectory) f the imaging spot forming region on the drawing object or in an imaging space above the drawing object.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the line may correspond to a line joining at least a portion of the imaging spot forming regions of the imaging spot forming region group at a predetermined position on the drawing object.

Data regarding a sampling pitch may be attached to the line.

The imaging spot data may be obtained based on image data of an image area determined based on the image data where a predetermined area including the coordinates of the position overlaps the image area by superposing the predetermined area on the image area.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the predetermined area may correspond to at least a portion of the regions of the imaging spot forming region group at a predetermined position on the drawing object.

In accordance with the present invention, there is further provided a second method of obtaining imaging spot data which is employed to draw an image on a drawing object by moving an imaging spot forming region in which the imaging spots are formed based on the image spot data relative to the drawing object and forming imaging spots in sequence on the drawing object with the movement of the imaging spot forming region based on the imaging spot data, wherein the improvement comprises the steps of obtaining original vector format image data of the image, obtaining information on imaging loci of the imaging spot forming region on the drawing object or in an imaging space above the drawing object for image drawing, obtaining information on the arrangement of the intersections of a contour of the image, represented by the image data or derivable from the image data, with the imaging loci of the imaging spot data on the drawing object corresponding to the information on the imaging loci and obtaining the imaging spot data corresponding to the information on loci of the imaging spot data based on the information on the arrangement of the intersections.

In the second method of obtaining imaging spot data, the imaging spot data locus may be divided into fractional imaging spot loci by the intersections shown by the intersection arrangement data, binary data may be alternately allotted to the fractional imaging spot loci in the order in which the fractional imaging spot loci is arranged and the binary data allotted to the fractional imaging spot loci may be sampled in the scanning direction on the image data corresponding to the direction of movement to obtain imaging spot data corresponding to the imaging spot data loci.

Further, the values of the coordinates of the intersection arrangement data in the scanning direction on the image data corresponding to the direction of movement may be obtained and the obtained values of the coordinates may be divided by the value of a predetermined interval in the scanning direction on the image data to obtain quantized values, and the difference between quantized values adjacent to the scanning direction on the image data may be obtained as run length data to obtain the imaging spot data corresponding to the imaging spot data loci by decoding the run length data.

Speed fluctuation information representing fluctuation in the actual movement of the drawing object upon image drawing with respect to a predetermined speed of relative movement of the drawing object may be obtained and the imaging spot data may be obtained while changing the predetermined interval so that the number of the imaging spot data increases in the imaging area where the actual movement of the drawing object is slower based on the obtained speed fluctuation information.

Further, a plurality of reference marks provided in predetermined positions on the drawing object may be detected to obtain detecting position information representing the positions of the reference marks, and the information on the loci of the spot forming region may be obtained based on the obtained detecting position information.

Further, information on deviation of direction of the actual movement of the drawing object upon image drawing from a predetermined relative movement direction of the drawing object set in advance may be obtained and the information on the loci of the spot forming region may be obtained based on the obtained deviation information.

Further, information on deviation of direction of the actual movement of the drawing object upon image drawing from a predetermined relative movement direction of the drawing object set in advance may be obtained and the information on the loci of the spot forming region may be obtained based on the obtained deviation information and the detecting position information described above.

In accordance with the present invention, there is further provided a first method of drawing for drawing an image on a drawing object by forming imaging spots on the drawing object based on imaging spot data, wherein the improvement comprises the steps of obtaining original vector format image data of the image, obtaining coordinates of a position on the image data corresponding to a position at which the imaging spots should be formed on the drawing object, obtaining the imaging spot data of the imaging spots based on the vector format image data and the coordinates of the position, and forming imaging spots on the drawing object based on the obtained imaging spot data.

In the first method of drawing of the present invention, the imaging spot data may be obtained based on image data of an image area to which the coordinates belong by superposing the image area determined based on the image data on the coordinates of the position.

In this case, the imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the coordinates of the position may correspond to a position of an imaging spot forming region at a predetermined position on the drawing object.

The imaging spot data may be obtained based on image data of an image area determined based on the image data where a line including the coordinates of the position overlaps by superposing the line on the image area.

A configuration may be adopted, wherein: the imaging spot data is obtained, based on the position at which the image data and the line intersect.

A configuration may be adopted, wherein the method of obtaining imaging spot data further comprises the step of: obtaining intersection arrangement data that indicates the intersections between the line and the contour of an image, represented by the image data or derivable from the image data; and wherein: the imaging spot data is obtained, based on the intersection arrangement data.

A configuration may be adopted, wherein: the line connects a plurality of the positional coordinates that correspond to a plurality of the imaging spots.

A configuration may be adopted, wherein: the line connects a plurality of the positional coordinates that correspond to a plurality of the imaging spots, arranged in order of temporal series.

A configuration may be adopted, wherein: the imaging spot data is used to draw an image by moving an imaging spot forming region in which the imaging spots are formed based on the image spot data relative to the drawing object and forming imaging spots in sequence on the drawing object with the movement of the imaging spot forming region, based on the imaging spot data; and the line connects a plurality of the positional coordinates that correspond to a plurality of the imaging spots, arranged in order of temporal series.

The imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the line may correspond to an imaging locus of the imaging spot forming region on the drawing object or in an imaging space above the drawing object.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the line may correspond to a line joining at least a portion of the imaging spot forming regions of the imaging spot forming region group at a predetermined position on the drawing object.

Data regarding a sampling pitch may be attached to the line.

The imaging spot data may be obtained based on image data of an image area determined based on the image data where a predetermined area including the coordinates of the position overlaps the image area by superposing the predetermined area on the image area.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the predetermined area may correspond to at least a portion of the regions of the imaging spot forming region group at a predetermined position on the drawing object.

In accordance with the present invention, there is further provided a second method of drawing for drawing an image on a drawing object by moving an imaging spot forming region in which the imaging spots are formed based on the image spot data relative to the drawing object based on imaging spot data and forming imaging spots in sequence on the drawing object with the movement of the imaging spot forming region based on the imaging spot data, wherein the improvement comprises the steps of obtaining original vector format image data of the image, obtaining information on imaging loci of the imaging spot forming region on the drawing object or in an imaging space above the drawing object for image drawing, obtaining information on the arrangement of the intersections of a contour of the image, represented by the image data or derivable from the image data, with the imaging loci of the imaging spot data on the drawing object corresponding to the information on the imaging loci, obtaining imaging spot data corresponding to the information on loci of the imaging spot data based on the information on the arrangement of the intersections and forming imaging spots on the drawing object by the imaging spot forming region based on the obtained imaging spot data.

In the second method of drawing, the imaging spot data locus may be divided into fractional imaging spot loci by the intersections shown by the intersection arrangement data, binary data may be alternately allotted to the fractional imaging spot loci in the order in which the fractional imaging spot loci are arranged and the binary data allotted to the fractional imaging spot loci may be sampled in the scanning direction on the image data corresponding to the direction of movement to obtain imaging spot data corresponding to the imaging spot data loci.

Further, the values of the coordinates of the intersection arrangement data in the scanning direction on the image data corresponding to the direction of movement may be obtained and the obtained values of the coordinates may be divided by the value of a predetermined interval in the scanning direction on the image data to obtain quantized values, and the difference between quantized values adjacent to the scanning direction on the image data may be obtained as run length data to obtain the imaging spot data corresponding to the imaging spot data loci by decoding the run length data.

Speed fluctuation information representing fluctuation in the actual movement of the drawing object upon image drawing with respect to a predetermined speed of relative movement of the drawing object set in advance may be obtained and imaging spot data may be obtained while changing the predetermined interval so that the number of the imaging spot data increases in the imaging area where the actual movement of the drawing object is slower based on the obtained speed fluctuation information.

Further, a plurality of reference marks provided in predetermined positions on the drawing object may be detected to obtain detecting position information representing the positions of the reference marks, and the information on the loci of the spot forming region may be obtained based on the obtained detecting position information.

Further, information on deviation of direction of the actual movement of the drawing object upon image drawing from a predetermined relative movement direction of the drawing object set in advance may be obtained and the information on the loci of the spot forming region may be obtained based on the obtained deviation information.

Further, information on deviation of direction of the actual movement of the drawing object upon image drawing from a predetermined relative movement direction of the drawing object set in advance may be obtained and the information on the loci of the spot forming region may be obtained based on the obtained deviation information and the detecting position information described above.

In accordance with a present invention, there is further provided a first system for obtaining imaging spot data which is employed to draw an image on a drawing object by forming imaging spots on the drawing object based on the imaging spot data wherein the improvement comprises: a position coordinate obtaining means for obtaining coordinates of a position on the image data corresponding to a position at which the imaging spots should be formed on the drawing object, and an imaging spot data obtaining means for obtaining original vector format image data of the image, and obtaining the imaging spot data of the imaging spots based on the obtained original vector format image data and the coordinates of the position obtained by the position coordinate obtaining means.

In the first system for obtaining imaging spot data of the present invention, the imaging spot data obtaining means may cause the imaging spot data to be obtained based on image data of an image area to which the coordinates belong by superposing the image area determined based on the image data on the coordinates of the position.

In this case, the imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the coordinates of the position may correspond to a position of an imaging spot forming region at a predetermined position on the drawing object.

The imaging spot data obtaining means may cause the imaging spot data to be obtained based on image data of an image area determined based on the image data where a line including the coordinates of the position overlaps by superposing the line on the image area.

A configuration may be adopted, wherein: the imaging spot data obtaining means obtains the imaging spot data, based on the position at which the image data and the line intersect.

The first system for obtaining imaging spot data may further comprise: intersection arrangement data obtaining means, for obtaining intersection arrangement data that indicates the intersections between the line and the contour of an image, represented by the image data or derivable from the image data; and the imaging spot data obtaining means may obtain the imaging spot data, based on the intersection arrangement data.

A configuration may be adopted, wherein: the line connects a plurality of the positional coordinates that correspond to a plurality of the imaging spots.

A configuration may be adopted, wherein: the line connects a plurality of the positional coordinates that correspond to a plurality of the imaging spots, arranged in order of temporal series.

A configuration may be adopted, wherein: the imaging spot data is used to draw an image by moving an imaging spot forming region in which the imaging spots are formed based on the image spot data relative to the drawing object and forming imaging spots in sequence on the drawing object with the movement of the imaging spot forming region, based on the imaging spot data; and the line connects a plurality of the positional coordinates that correspond to a plurality of the imaging spots, arranged in order of temporal series.

The imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the line may correspond to an imaging locus of the imaging spot forming region on the drawing object or in an imaging space above the drawing object.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the line may correspond to a line joining at least a portion of the imaging spot forming regions of the imaging spot forming region group at a predetermined position on the drawing object.

Data regarding a sampling pitch may be attached to the line.

The imaging spot data may be obtained based on image data of an image area determined based on the image data where a predetermined area including the coordinates of the position overlaps the image area by superposing the predetermined area on the image area.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the predetermined area may correspond to at least a portion of the regions of the imaging spot forming region group at a predetermined position on the drawing object.

In accordance with the present invention, there is further provided a second system for obtaining imaging spot data which is employed to draw an image on a drawing object by moving an imaging spot forming region in which the imaging spots are formed based on the image spot data relative to the drawing object and forming imaging spots in sequence on the drawing object with the movement of the imaging spot forming region based on the imaging spot data, wherein the improvement comprises: imaging locus information obtaining means for obtaining information on imaging loci of the imaging spot forming region on the drawing object or in an imaging space above the drawing object for image drawing, an intersection arrangement data obtaining means for obtaining original vector format image data of the image and obtaining information on the arrangement of the intersections of a contour of the image, represented by the image data or derivable from the image data, with the imaging loci of the imaging spot data on the drawing object corresponding to the information on the imaging loci and an imaging spot data obtaining means for obtaining imaging spot data corresponding to the information on the imaging loci based on the information on the arrangement of the intersections obtained by the intersection arrangement data obtaining means.

In the second system for obtaining imaging spot data, the imaging spot data obtaining means may cause the imaging spot data locus to divide into fractional imaging spot loci by the intersections shown by the intersection arrangement data, binary data to be alternately allotted to the fractional imaging spot loci in the order in which the fractional imaging spot loci are arranged and the binary data allotted to the fractional imaging spot loci to be sampled in the scanning direction on the image data corresponding to the direction of movement to obtain imaging spot data corresponding to the imaging spot data loci.

Further, the imaging spot data obtaining means may cause the values of the coordinates of the intersection arrangement data in the scanning direction on the image data corresponding to the direction of movement to be obtained and the obtained values of the coordinates to be divided by the value of a predetermined interval in the scanning direction on the image data to obtain the difference between quantized values adjacent to the scanning direction on the image data, and the difference to be obtained as run length data to obtain the imaging spot data corresponding to the imaging spot data loci by decoding the run length data.

Speed fluctuation information obtaining means for obtaining speed fluctuation information representing fluctuation in the actual movement of the drawing object upon image drawing with respect to a predetermined speed of relative movement of the drawing object set in advance may be further provided and the imaging spot data obtaining means may obtain imaging spot data while changing the predetermined interval so that the number of the imaging spot data increases in the imaging area where the actual movement of the drawing object is slower based on the obtained speed fluctuation information.

Further, a position information detecting means for detecting a plurality of reference marks provided in predetermined positions on the drawing object and obtaining detecting position information representing the positions of the reference marks may be further provided, and the imaging locus obtaining means may obtain the information on the loci of the spot forming region based on the detecting position information obtained by the position information detecting means.

Further, a deviation information obtaining means for obtaining information on deviation of direction of the actual movement of the drawing object upon image drawing from a predetermined relative movement direction of the drawing object set in advance may be further provided and the imaging spot locus information may obtain the information on the loci of the spot forming region based on the deviation information obtained by the deviation information obtaining means. Further, a deviation information obtaining means for obtaining information on deviation of direction of the actual movement of the drawing object upon image drawing from a predetermined relative movement direction of the drawing object set in advance may be further provided and the imaging spot locus information may obtain the information on the loci of the spot forming region based on the deviation information obtained by the deviation information obtaining means and the detecting position information obtained by the position information detecting means.

In accordance with the present invention, there is further provided a first system for drawing, for drawing an image on the drawing object by forming imaging spots on the drawing object based on imaging spot data, wherein the improvement comprises: a position coordinate obtaining means for obtaining coordinates of a position on original vector format image data corresponding to a position of the imaging spot on the drawing object, and an imaging spot data obtaining means for obtaining original vector format image data of an image, and obtaining the imaging spot data of the imaging spots based on the obtained original vector format image data and the coordinates of the position obtained by the position coordinate obtaining means.

In the first system for drawing of the present invention, the imaging spot data obtaining means may cause the imaging spot data to be obtained based on image data of an image area to which the coordinates belong by superposing the image area determined based on the image data on the coordinates of the position.

In this case, the imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the coordinates of the position may correspond to a position of an imaging spot forming region at a predetermined position on the drawing object.

The imaging spot data obtaining means may cause the imaging spot data to be obtained based on image data of an image area determined based on the image data where a line including the coordinates of the position overlaps by superposing the line on the image area.

A configuration may be adopted, wherein: the imaging spot data obtaining means obtains the imaging spot data, based on the position at which the image data and the line intersect.

The first system for drawing may further comprise: intersection arrangement data obtaining means, for obtaining intersection arrangement data that indicates the intersections between the line and the contour of an image, represented by the image data or derivable from the image data; and the imaging spot data obtaining means may obtain the imaging spot data, based on the intersection arrangement data.

A configuration may be adopted, wherein: the line connects a plurality of the positional coordinates that correspond to a plurality of the imaging spots.

A configuration may be adopted, wherein: the line connects a plurality of the positional coordinates that correspond to a plurality of the imaging spots, arranged in order of temporal series.

A configuration may be adopted, wherein: the imaging spot data is used to draw an image by moving an imaging spot forming region in which the imaging spots are formed based on the image spot data relative to the drawing object and forming imaging spots in sequence on the drawing object with the movement of the imaging spot forming region, based on the imaging spot data; and the line connects a plurality of the positional coordinates that correspond to a plurality of the imaging spots, arranged in order of temporal series.

The imaging spot data may be used to draw an image by moving an imaging spot forming region in which the imaging spots are formed based on the image spot data relative to the drawing object and forming imaging spots in sequence on the drawing object with the movement of the imaging spot forming region based on the imaging spot data, and the line may correspond to an imaging locus of the imaging spot forming region on the drawing object or in an imaging space above the drawing object.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the line may correspond to a line joining at least a portion of the imaging spot forming regions of the imaging spot forming region group at a predetermined position on the drawing object.

Data regarding a sampling pitch may be attached to the line.

The imaging spot data may be obtained based on image data of an image area determined based on the image data where a predetermined area including the coordinates of the position overlaps the image area by superposing the predetermined area on the image area.

The imaging spot data may be used to draw an image by moving an imaging spot forming region group comprising a plurality of imaging spot forming regions in which the imaging spots are formed based on the image spot data relative to the drawing object and forming imaging spots in sequence corresponding to the imaging spot forming region group on the drawing object with the movement of the imaging spot forming region group based on the imaging spot data, and the predetermined area may correspond to at least a portion of the regions of the imaging spot forming region group at a predetermined position on the drawing object.

In accordance with the present invention, there is further provided a second system for drawing, for drawing an image on a drawing object by moving an imaging spot forming region in which the imaging spots are formed based on the image spot data relative to the drawing object and forming imaging spots in sequence on the drawing object with the movement of the imaging spot forming region based on the imaging spot data, wherein the improvement comprises: imaging locus information obtaining means for obtaining information on imaging loci of the imaging spot forming region on the drawing object or in an imaging space above the drawing object for image drawing, an intersection arrangement data obtaining means for obtaining vector format image data representing an image and obtaining information on the arrangement of the intersections of a contour of the image, represented by the image data or derivable from the image data, with the imaging loci of the imaging spot data on the drawing object corresponding to the information on the imaging loci and an imaging spot data obtaining means for obtaining imaging spot data corresponding to the information on the imaging loci based on the information on the arrangement of the intersections obtained by the intersection arrangement data obtaining means.

In the second system for drawing, the imaging spot data obtaining means may cause the imaging spot data locus to divide into fractional imaging spot loci by the intersections shown by the intersection arrangement data, binary data to be alternately allotted to the fractional imaging spot loci in the order in which the fractional imaging spot loci are arranged and the binary data allotted to the fractional imaging spot loci to be sampled in the scanning direction on the image data corresponding to the direction of movement to obtain imaging spot data corresponding to the imaging spot data loci.

Further, the imaging spot data obtaining means may cause the values of the coordinates of the intersection arrangement data in the scanning direction on the image data corresponding to the direction of movement to be obtained and the obtained values of the coordinates to be divided by the value of a predetermined interval in the scanning direction on the image data to obtain the difference between quantized values adjacent to the scanning direction on the image data, and the difference to be obtained as run length data to obtain the imaging spot data corresponding to the imaging spot data loci by decoding the run length data.

Speed fluctuation information obtaining means for obtaining speed fluctuation information representing fluctuation in the actual movement of the drawing object upon image drawing with respect to a predetermined speed of relative movement of the drawing object set in advance may be further provided and the imaging spot data obtaining means may obtain imaging spot data while changing the predetermined interval so that the number of the imaging spot data increases in the imaging area where the actual movement of the drawing object is slower based on the obtained speed fluctuation information.

Further, a position information detecting means for detecting a plurality of reference marks provided in predetermined positions on the drawing object and obtaining detecting position information representing the positions of the reference marks may be further provided, and the imaging locus obtaining means may obtain the information on the loci of the spot forming region based on the detecting position information obtained by the position information obtaining means.

Further, a deviation information obtaining means for obtaining information on deviation of direction of the actual movement of the drawing object upon image drawing from a predetermined relative movement direction of the drawing object set in advance may be further provided and the imaging spot locus information may obtain the information on the loci of the spot forming region based on the deviation information obtained by the deviation information obtaining means. Further, a deviation information obtaining means for obtaining information on deviation of direction of the actual movement of the drawing object upon image drawing from a predetermined relative movement direction of the drawing object set in advance may be further provided and the imaging spot locus information may obtain the information on the loci of the spot forming region based on the deviation information obtained by the deviation information obtaining means and the detecting position information obtained by the position information detecting means.

The “spot forming region” as used herein may be formed by any means so long as it forms a spot forming region on a drawing object. For example, the imaging spots may be formed by a light beam reflected by the modulator element of a spatial light modulator such as a DMD, or by a light beam as it is emitted by a light source or by ink discharged from the nozzles of an ink jet printer.

Further, the expression “to divide the imaging spot data locus into fractional imaging spot loci by the intersections shown by the intersection arrangement data” may mean “to divide the imaging spot data locus into fractional imaging spot loci by all the intersections shown by the intersection arrangement data” or in the case, for instance, where two images overlap each other and a part of one of the two images is inside the other image, the intersection between the contour of the inner image and the locus of the imaging spot data may be considered not to exist in the part when the fractional imaging spot loci are obtained.

Further, “0” data and “1” data may be employed as the “binary data”. In addition, any other form of two valued data may be employed.

In the present invention, the imaging spot data may be obtained as multi-valued data obtained other than the binary data by the use of multi-valued information, for instance, when the vector format image data has the multi-valued information.

According to the method of and the system for obtaining imaging spot data of the present invention as well as the method of and the system for drawing of the present invention, since the original vector format image data of an image is obtained and the imaging spot data is directly obtained from the vector format image data, the imaging spot data can be directly obtained from the vector format image data without converting the vector format image data to the raster form image data as in the conventional, whereby the accuracy in drawing an image can be improved without deteriorating the processing speed or increasing the cost.

### BRIEF DESCRIPTION OF THE DRAWINGS

FIG. 1 is a perspective view of an exposure system employing one of first to fourth embodiments of the present invention,

FIG. 2 is a perspective view of the scanner of the exposure system shown in FIG. 1,

FIG. 3A is a plan view showing the exposed area on the exposing face of the substrate,

FIG. 3B is a plan view showing the arrangement of the exposed area by each exposure head,

FIG. 4 is a view showing the DMD in the exposure head of the exposure system shown in FIG. 1,

FIG. 5 is a block diagram showing an electric arrangement of the exposure system employing the first embodiment of the present invention,

FIG. 6A is a view showing an example of an exposed image represented by vector format exposed image data,

FIG. 6B is a view showing vectors represented by intermediate vector data generated based on the exposed image data of the exposed image shown in FIG. 6A,

FIG. 7 is a view for describing a method of generating intermediate vector data in the case where the exposed images overlap each other,

FIG. 8 is a schematic view showing a relation between the reference marks on an optimally-shaped substrate and information on a passing position of a predetermined micro mirror,

FIG. 9 is a view for describing obtainment of information on the exposing locus of the micro mirror,

FIG. 10 is a view for description of obtaining exposure spot data loci based on the information on the exposing locus of the micro mirror,

FIG. 11 is a view for description of obtaining the intersection arrangement data from the exposure spot data loci and the intermediate vector data,

FIG. 12 is a flow chart for description of a method of calculating the intersection arrangement data in the case where the vector represented by the intermediate vector data is a line segment,

FIG. 13 is a flow chart for description of a method of calculating the intersection arrangement data in the case where the vector represented by the intermediate vector data is a circular segment,

FIG. 14 is a flow chart for description of a method of calculating the intersection arrangement data in the case where the vector represented by the intermediate vector data is a circular segment,

FIG. 15 is a view for description of obtainment of exposing spot data of the micro mirror based on the intersection arrangement data,

FIG. 16 is a view for description of the exposing spot data train of each micro mirror,

FIG. 17 is a view showing the frame data,

FIG. 18 is a view showing another method of obtaining exposing spot data of the micro mirror based on the intersection arrangement data,

FIG. 19 is a view for describing a method of obtaining exposing spot data according to expansion/contraction of the substrate,

FIG. 20 is a block diagram showing an electric arrangement of the exposure system employing the second embodiment of the present invention,

FIG. 21 is a view for describing deviation from the direction of movement of the movable stage,

FIG. 22 is a view showing the exposing locus of the micro mirror,

FIG. 23 is a view for describing a method of obtaining the intersection arrangement data from the exposing spot and the intermediate vector data

FIG. 24 is a block diagram showing an electric arrangement of the exposure system employing the third embodiment of the present invention,

FIG. 25 is a view for describing a method of obtaining the exposing spot data loci based on the information on the exposing locus of the micro mirror,

FIG. 26 is a block diagram showing an electric arrangement of the exposure system employing the fourth embodiment of the present invention,

FIG. 27 is a view showing the exposing locus of the micro mirror and the exposure timing of the micro mirror,

FIG. 28 is a part of a flow chart for describing an exposure system employing all the first to fourth embodiments of the present invention,

FIG. 29 is the other part of a flow chart for describing an exposure system employing all the first to fourth embodiments of the present invention,

FIG. 30A is a schematic view showing an image exposed by a conventional exposure system,

FIG. 30B is a schematic view showing an image exposed by an exposure system employing an embodiment of the present invention,

FIG. 31 is a view for describing a method of obtaining the coordinates of the intersections without generating the intermediate vector data,

FIG. 32 is a view for describing another embodiment of the method of obtaining the exposing spot data,

FIG. 33 is a view for describing still another embodiment of the method of obtaining the exposing spot data,

FIG. 34 is a view for describing yet still another embodiment of the method of obtaining the exposing spot data,

FIG. 35 is a view for describing yet still another embodiment of the method of obtaining the exposing spot data,

FIG. 36 is a view for describing yet still another embodiment of the method of obtaining the exposing spot data,

FIG. 37 is a view for describing yet still another embodiment of the method of obtaining the exposing spot data,

FIG. 38 is a view for describing yet still another embodiment of the method of obtaining the exposing spot data,

FIG. 39 is a view for describing yet still another embodiment of the method of obtaining the exposing spot data,

FIGS. 40A and 40B are views for describing other embodiments of the method of obtaining the exposing spot data, and

FIG. 41 illustrates deformed contour vectors.

### BEST MODE FOR CARRYING OUT THE INVENTION

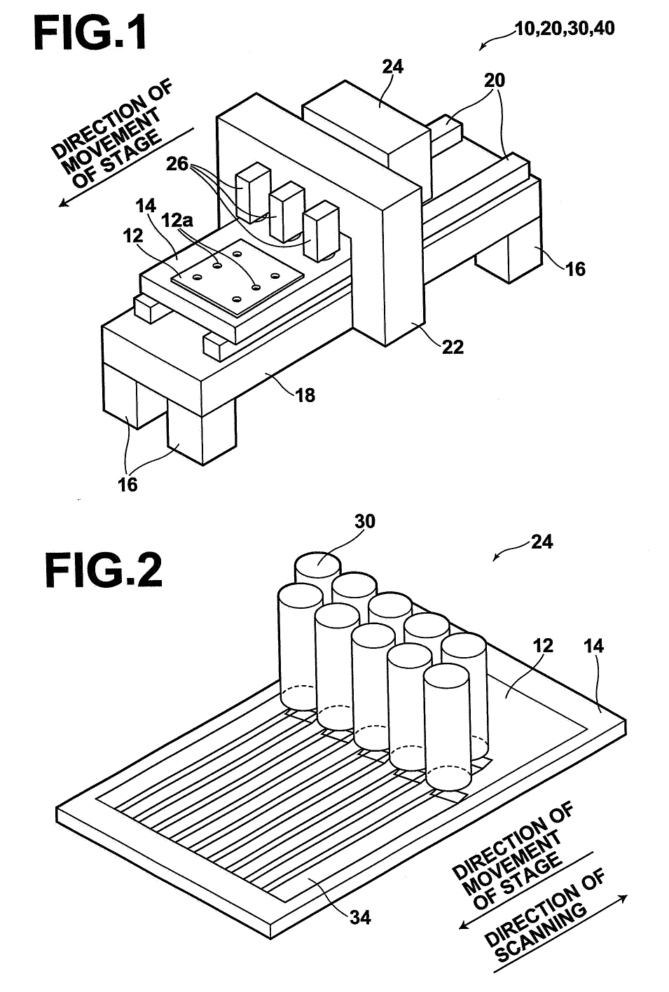

An exposure system employing a first embodiment of a method of and a system for obtaining an image data of the present invention and a method of and a system for forming an image of the present invention will be described with reference to the drawings, hereinbelow. FIG. 1 is a perspective view showing in brief an exposure system employing a first embodiment of the present invention. The exposure system is for exposing a circuit pattern of each layer of a multiple-layered printed circuit board, and characterized by the method of obtaining the exposing spot data used for exposing the circuit pattern of each layer of the multiple-layered printed circuit board. The structure of the exposure system will be briefly described first.

In FIG. 1, the exposure system 10 is provided with a plate-like movable stage 14 which attracts a glass substrate 12 against its surface, thereby holding the glass substrate 12. A thick plate-like table 18 is supported by four legs 16 and a pair of guides 20 extends in the direction of movement of the movable stage 14 on the upper surface of the table 18. The movable stage 14 is disposed so that its longitudinal direction is directed toward the direction of movement of the movable stage 14 and is movable back and forth along the guides 20.

A substantially U-shaped gate 22 extends across the path of movement of the movable stage 14 at the center of the table 18. The opposite ends of the gate 22 are respectively fixed to the corresponding side surfaces of the table 18. On one side of the gate 22, a scanner 24 is provided, and on the other side of the gate 22, a plurality of cameras 26 for detecting the leading end and the trailing end of the glass substrate 12 and a plurality of circular reference marks 12a on the substrate 12 are provided.

The reference marks 12a on the substrate 12 are, for instance, holes which are formed in advance on the substrate 12 based on preset information on the position of the reference marks. Lands, or etching marks may be used instead of holes. Further, for instance, a part of a circuit pattern to be exposed on the substrate 12 may be used as the reference marks 12a. Though only six reference marks 12a are shown in FIG. 1, actually more reference marks 12a are provided. Alternatively, the edges of the substrate 12 may be detected and employed as the reference marks 12a.

The scanner 24 and the cameras 26 are mounted on the gate 22 to be fixedly positioned above the path of movement of the movable stage 14 and are connected to a controller (to be described later) for controlling them.

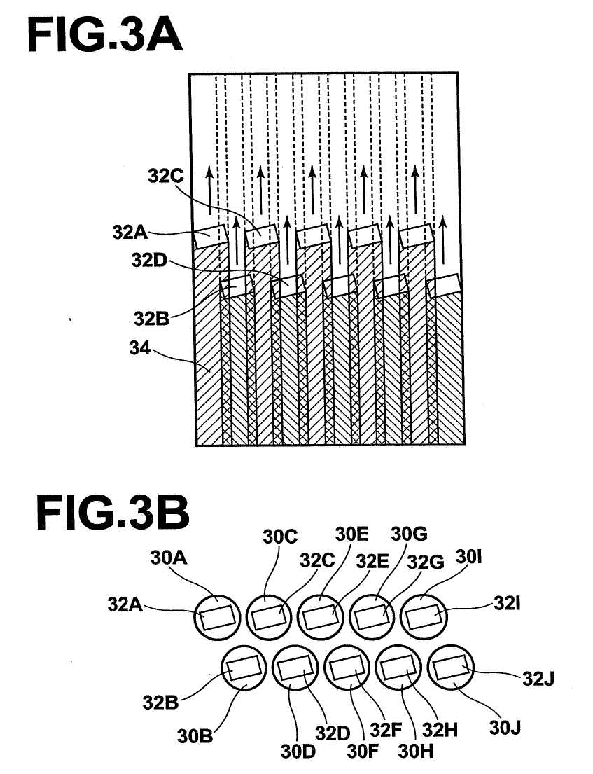

As shown in FIGS. 2 and 3B, the scanner 24 is provided with ten exposure heads 30 (30A to 30J) which are substantially arranged in a matrix of 2 rows×5 columns.

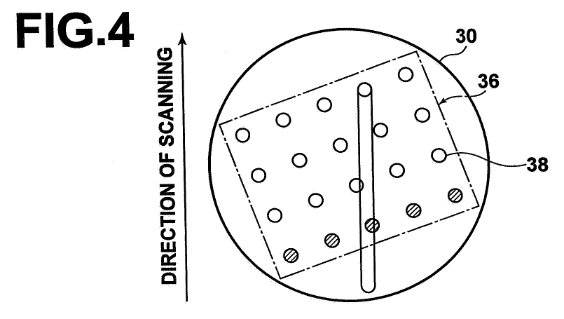

As shown in FIG. 4, a digital micro mirror device (DMD) 36 which is a spatial modulator element (SLM) for spatial modulation of a light beam impinging thereon are disposed inside each of the exposure head 30. The DMD 36 has a number of two-dimensionally arranged micro mirrors 38 arranged in a direction in which the micro mirror 38 is perpendicular, and are mounted so that the row of the micro mirrors 38 is at a predetermined set inclination angle θ to the scanning direction. With this arrangement, the area 32 exposed by each exposure head 30 is a rectangular area inclined to the scanning direction. Accordingly, with the movement of the movable stage 14, a strip-like exposed area 34 is formed on the substrate 12 for each exposure head 30. Though the light source for causing the light beam to enter each of the exposure heads 30 is abbreviated in the drawings, for instance, a laser can be used.

The DMD 36 of each exposure head 30 is turned on/off based on a micro mirror unit and a dot pattern (black/white) corresponding to the micro mirrors 38 of the DMD 36 is exposed on the substrate 12. The strip-like exposed areas 34 are formed by two-dimensionally arranged dots corresponding to the micro mirrors 38 shown in FIG. 4. Since the two-dimensionally arranged dot pattern is inclined with respect to the scanning direction, the dots arranged in the scanning direction passes between the dots arranged in a direction intersecting the scanning direction, whereby high resolution can be realized. Dots which are not used can exist due to fluctuation in adjustment of the inclined angle. For example, the dots hatched in FIG. 4 are not used, and the mirrors 38 in the DMD 36 corresponding to the dots are always off.

As shown in FIGS. 3A and 3B, the exposure head 30 in each of the lines are shifted by a predetermined distance in the direction of the arrangement so that each of the strip-like exposed areas 34 partly overlaps with those adjacent thereto. Accordingly, for instance, an area between the leftmost exposing area 32A in the first row and the next leftmost exposing area 32C in the first row which cannot be exposed by either of the exposing areas is exposed by the leftmost exposing area 32B in the second row. Similarly, an area between the exposing area 32B and an area 32D next to the exposing area 32B which cannot be exposed by either of the exposing areas is exposed by the exposing area 32C.

The electric structure of the exposure system 10 will be described next.

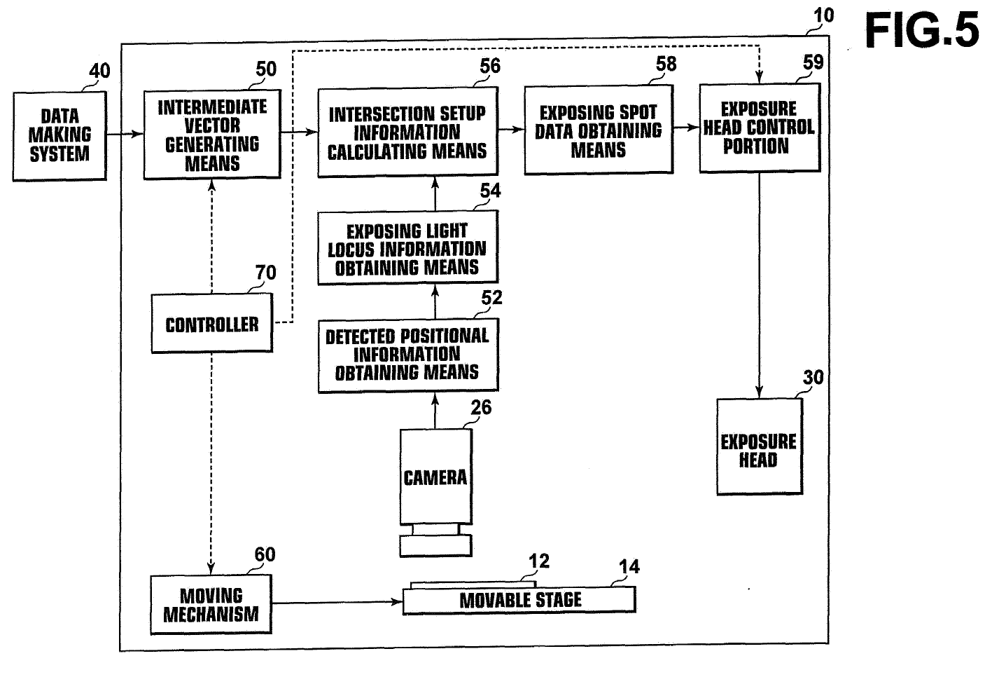

As shown in FIG. 5, the exposure system 10 comprises an intermediate vector generating means 50 which obtains data in a form of a vector representing an exposure image to be exposed output from a data making system 40 having a CAM (computer aided manufacturing) station and generates an intermediate vector data, a detected positional information obtaining means 52 which obtains information on the position of the reference marks 12a based on images of the reference marks 12a taken by the cameras 26, an exposing light locus information obtaining means 54 which obtains information on loci of the exposing light of each of the micro mirrors 38 on the substrate 12 upon a real exposure based on the information on the position obtained by the detected positional information obtaining means 52, an intersection arrangement data calculating means 56 which calculates information on the arrangement of the intersections of vectors represented by the intermediate vector data and the loci of the imaging spot data on the intermediate vector data corresponding to the information on the on the exposing light loci basis of the information on the exposing light loci for each micro mirror 38 obtained by the exposing light locus information obtaining means 54 and the intermediate vector data output from the intermediate vector generating means 50, an exposing spot data obtaining means 58 which obtains exposing spot data corresponding to the exposing spot data loci for each micro mirror 38 based on information on the intersection setup obtained by the intersection arrangement data calculating means 56, an exposure head control portion 59 which controls each micro mirror 38 of each exposure head 30 based on the exposing spot data obtained by the exposing spot data obtaining means 58, a moving mechanism 60 which drives the movable stage 14 in the stage moving direction and a controller 70 which controls the overall system of this embodiment. The moving mechanism 60 may be of any known structure so long as it moves the movable stage 14 back and forth along the guides 20. The intermediate vector data, the exposing spot data, the intersection arrangement data and the elements described above will be described in detail later.

Operation of the exposure system 10 will be described, hereinbelow, with reference to the drawings.

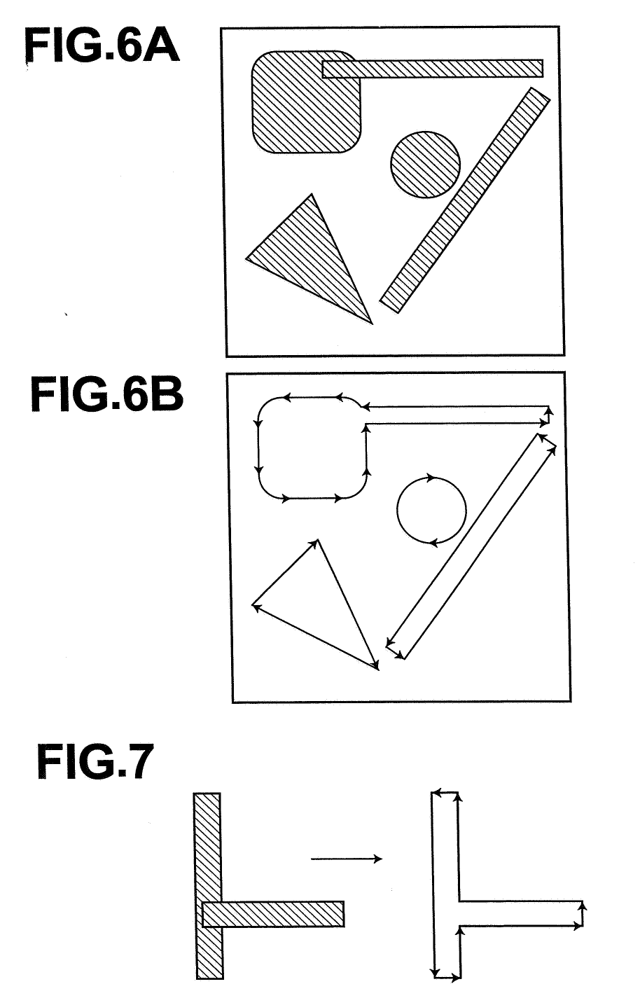

In the data making system 40, original vector format image data of an exposure image, which is to be exposed on the substrate 12 is first made and is output to the intermediate vector generating means 50. The intermediate vector generating means 50 generates intermediate vector data based on the input vector format image data. The “intermediate vector data” is data in which the contour of the image to be exposed in the vector format is expressed in the vector format. FIG. 6A shows an example of an image expressed in the vector format image data, and FIG. 6B shows vectors represented by the intermediate vector data generated based on the image data of the image shown in FIG. 6A. The hatched portion in FIG. 6A is the image represented by the image data and the portion indicated at arrows in FIG. 6B is the vector which is represented by the intermediate vector data. In this specification, the term “vector” includes not only the vectors expressed in a straight line but also those expressed in a curved line as shown in FIG. 6B. As for the method of generating the intermediate vector data, for instance, when the vector format image data is in area vector data, the intermediate vector data may be generated by the use of data representing the contour of the image in the area vector data. Further, when the vector format image data comprises data showing the direction of a line segment and data showing the thickness of the line segment, the input vector format image data may be converted to area vector format data based on the data showing the thickness of the line segment and the intermediate vector data may be generated by the use of data representing the contour of the image in the area vector data.

Note that during formation of the intermediate vector data, a vector that represents a contour may be designated as a boundary. Then, data indicating whether either side of the boundary is ON or OFF may be attached to the intermediate vector data. For example, data may be attached that indicates that the direction in which Y increases is ON or OFF (in the case that the vector is parallel with the Y direction, the direction in which X increases may be ON or OFF). Alternatively, contour vectors may be generated such that the right side is designated as ON and the left side is designated as OFF, from the starting point to the end point. By forming the intermediate vector data in this manner, assignment of ON/OFF values is facilitated during obtainment of exposure point data, which will be described later.

In this embodiment, when two images are poisoned to overlap each other as shown in FIG. 6A, the two images are integrated to form an image represented by a single contour and intermediate vector data of the single image is generated as shown in FIGS. 6B and 7. However, not limited to this form, respective pieces of intermediate vector data may be generated for two images overlapping each other.

The intermediate vector data thus generated is output to the intersection arrangement data calculating means 56 from the intermediate vector generating means.

While the intermediate vector data is thus generated, information on the exposing light loci on the substrate 12 upon real exposure of each micro mirror 38 of the DMD 36 of each exposure head 30 is obtained. Note that in the case that a multi-layered substrate is formed, it is necessary to draw the pattern of an upper layer to match that of a lower layer. In this case, the exposing light loci within an imaging space above the substrate is defined.

Specifically, the controller 70 outputs a control signal to the moving mechanism 60, and the moving mechanism 60 once moves the movable stage 14 upstream along the guides 20 from the position shown in FIG. 1 and then moves the same in the direction of movement of the movable stage 14 at a desired speed in response to the control signal.

When the substrate 12 on the movable stage 14 which is moved in the manner described above passes below a plurality of the cameras 26, the cameras 26 take an image of the substrate 12, and a piece of image data representing the image taken by the cameras 26 is input into the detected positional information obtaining means 52. The detected positional information obtaining means 52 obtains detected positional information representing information on the detected position of the reference marks 12a on the substrate 12 based on the input image data. Though may be obtained, for instance, by extracting a circular image, the detected positional information of the reference marks 12a may be detected by any other known methods. The detected positional information of the reference marks 12a is specifically obtained as the values of coordinates whose origin may be a corner of the four corners represented by image data of the substrate 12, a predetermined position of image data or a position of one of the reference marks 12a. It is assumed that the detected positional information and the positional information of the reference marks 12a conform to each other in coordinate system. In this embodiment, the cameras 26 and the detected positional information obtaining means 54 form the position information detecting means.

The detected positional information of the reference marks 12a thus obtained is output to the exposing light locus information obtaining means 54 from the detected positional information obtaining means 52.

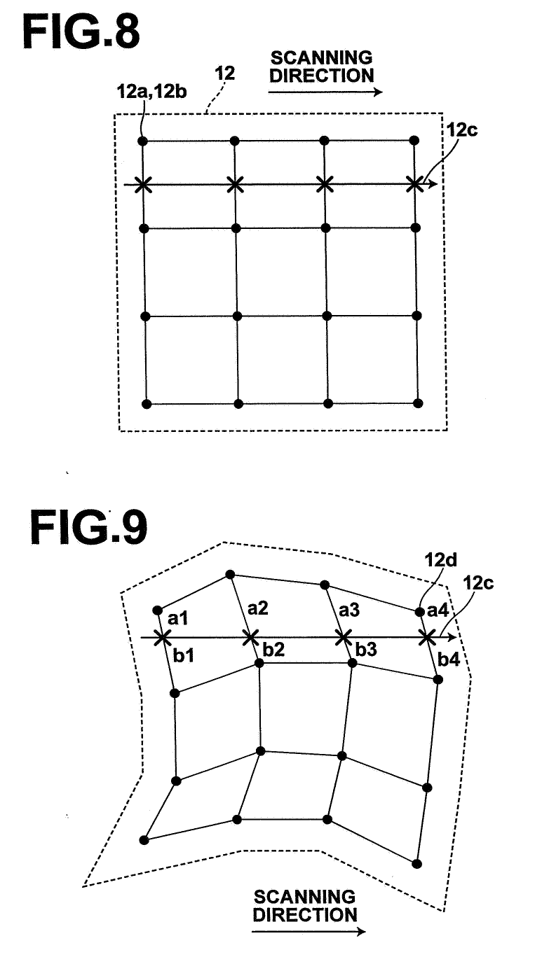

In the exposing light locus information obtaining portion 54, information on loci of the exposing light from each of the micro mirrors 38 on the substrate 12 upon a real exposure is obtained based on the input detected positional information. Specifically, a passing position information representing the position where an image of each micro mirror 38 of the DMD 36 of each exposure head 30 passes has been set in advance for each micro mirror 38 in the exposing light locus information obtaining portion 54. The passing position information has been set in advance depending on the position of each exposure head 30 with respect to the setting position of the substrate 12 on the movable stage 14 and is represented by a plurality of vectors or values of the coordinates of a plurality of points with the origin on the same position as the detected positional information and the positional information of the reference marks 12a. Further, it is assumed that the coordinate system of the passing position information is the same as those of the detected positional information and the positional information of the reference marks 12a. FIG. 8 shows the relation between a substrate 12 which does not undergo a press step or the like, that is, there have been generated no deformation such as strain in the substrate 12, and which is ideal in shape so that the reference marks 12a are correctly positioned in positions indicated by the preset reference mark positional information 12b and the passing position information 12c of a predetermined micro mirror 38. Note that the passing position information 12c may be obtained, based on the results of measurement of the position of the beam spot on the substrate 12.

In the exposing light locus information obtaining means 54, the values of the coordinates of the intersections of a straight line joining pieces of the detected positional information 12d adjacent to each other in the direction perpendicular to the scanning direction and a straight line represented by the passing position information 12c of each micro mirror 38 are obtained as shown in FIG. 9. That is, the values of the coordinates of points attached with an x mark in FIG. 9 are obtained and the distances between the points attached with an x mark and the detected positional information 12d adjacent thereto in the perpendicular direction are obtained and ratios of the distance between the points attached with an x mark and one piece of the detected positional information 12d adjacent thereto in the perpendicular direction and the distance between the points attached with an x mark and the other detected positional information 12d are obtained. Specifically, a1:b1, a2:b2, a3:b3 and a4:b4 in FIG. 9 are obtained as the exposing light locus information. The ratios obtained in the manner described above represent the exposing light locus of the micro mirror 38 on the substrate 12 after deformation. That is, the ratios obtained in the manner described above represent the exposing light locus of the micro mirror 38 on the substrate 12 (exposing light locus within the imaging space above the substrate 12) upon real exposure.

The exposing light locus information thus obtained for each micro mirror 38 is input into the intersection arrangement data calculating means 56.

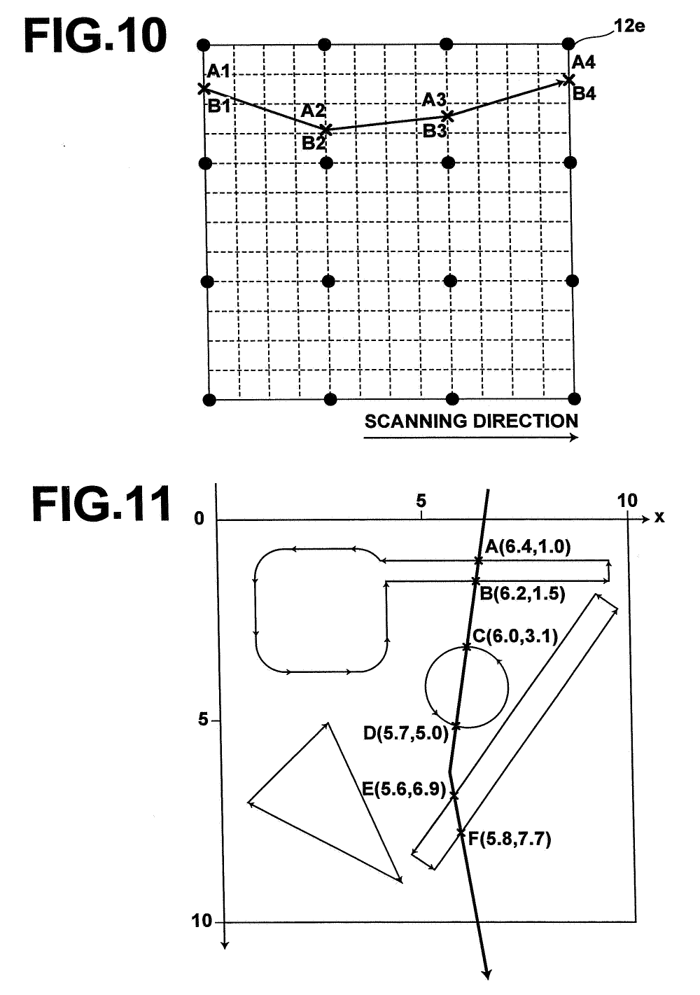

In the intersection arrangement data calculating means 56, the coordinate system of the intermediate vector data such as shown in FIG. 10 has been set in advance. The coordinate system of the intermediate vector data is also the coordinate system of the image data and conforms to all the coordinate systems of the positional information of the reference marks 12a, the detected positional information and the passing position information. As shown in FIG. 10, image data reference position information 12e is positioned in a position corresponding to the position shown by the reference mark positional information 12b. In the intersection arrangement data calculating means 56, values of the coordinates of the points dividing the straight line joining pieces of the image data reference position information 12e adjacent to each other in the direction perpendicular to the scanning direction by the ratio shown by the exposing light locus information obtained as described above. That is, values of the coordinates of the points satisfying the following formulae are obtained.

a1:b1=A1:B1

a2:b2=A2:B2

a3:b3=A3:B3

a4:b4=A4:B4.

Then a straight line joining the dividing points obtained in the manner described above is obtained. The straight line shows the exposing spot data loci on the image data corresponding to the exposing light data loci of the micro mirror 38 on the substrate 12 upon real exposure.

The exposing spot data loci may be a straight line joining the dividing points obtained based on the ratios shown by the exposing light locus information or may be a curved line joining the dividing points by, for instance, a spline interpolation. When joining the dividing points with a curved line by a spline interpolation or the like, an exposing spot data loci more faithful to deformation of the substrate 12 can be obtained.

Then as shown in FIG. 11, the exposing spot data loci and the intermediate vector data obtained in the manner described above are plotted on the same coordinate system, and information on the arrangement of the intersections of the vectors represented by the intermediate vector data and the exposing spot is obtained. The information on the arrangement of the intersections means here the coordinates of the intersections. That is, the coordinates of the intersections A to F in FIG. 11 are obtained. The exposing spot data loci parted by the intersections A to F in FIG. 11 are the fractional imaging spot data loci.

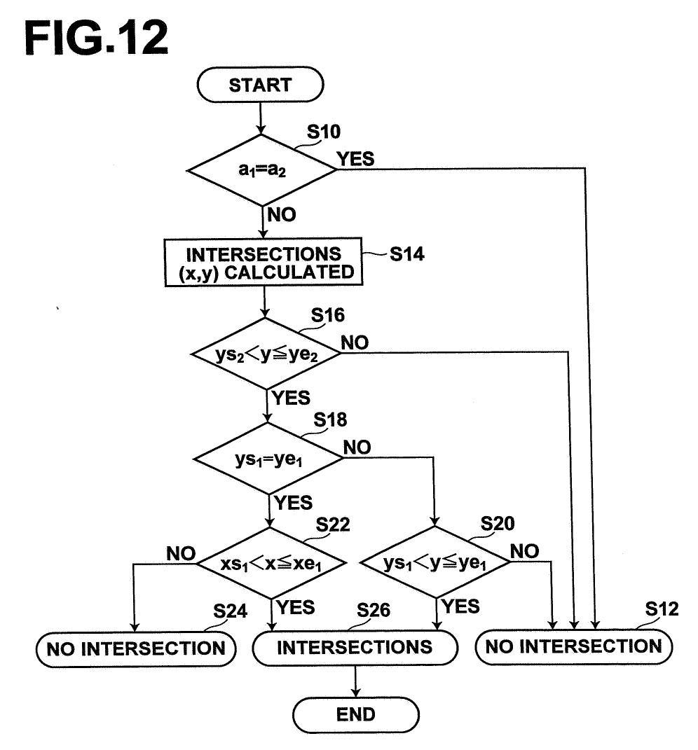

A method of calculating the intersection arrangement data will be specifically described, hereinbelow. It is assumed, for instance, that the vectors represented by the intermediate vector data are line segments represented by the following formula (1) and the exposing spot data loci are line segments represented by the following formula (2). A method of calculating the intersection arrangement data in this case will be described with reference to the flow chart shown in FIG. 12.

x=a₁y+b₁, xₛ₁≦x≦xₑ₁, yₛ₁≦y≦yₑ₁ (1)

x=a₂y+b₂, xₛ₂≦x≦xₑ₂, yₛ₂≦y≦yₑ₂ (2)

As shown in the flow chart in FIG. 12, a₁ in formula (1) and a₂ in formula (2) are compared with each other, that is, inclinations of the line segments are compared with each other (step S10). When a₁ in formula (1) and a₂ in formula (2) are equal to each other, the processing is ended since there is no intersection (step S12). When it is determined in step S10 that a₁ in formula (1) and a₂ in formula (2) are not equal to each other, calculation of the intersection is carried out (step S14). Specifically, x coordinates and y coordinates of intersections are calculated according to the following.

Since a₁y+b₁=a₂y+b₂

y=(b₂−b₁)/(a₁−a₂)

x=a₁y+b₁

Then whether the intersection is on the exposing spot loci is determined by comparing the value of y coordinate obtained in the manner described above with yₛ₂ and yₑ₂ (step S16). When yₛ₂<y≦yₑ₂ is not satisfied, that there is no intersection is determined and the calculation is ended (step S12). Whereas when yₛ₂<y≦yₑ₂ is satisfied, whether the vector represented by the intermediate vector data is parallel to the x axis is checked by checking whether yₛ₁ and yₑ₁ are equal to each other (step S18). When the vector is not parallel to the x axis, whether the intersection obtained in the manner described above is on the vector represented by the intermediate vector data is checked by comparing the value of the y coordinate with yₛ₁ and yₑ₁ (step S20). When yₛ₁<y≦yₑ₁ is not satisfied, that there is no intersection is determined and the calculation is ended (step S12). When yₛ₁<y≦yₑ₁ is satisfied, that there is an intersection is determined and the x coordinate and the y coordinate obtained in the manner described above are obtained. Whereas when it is determined in step S18 that the vector represented by the intermediate vector data is parallel to the x axis, whether the intersection obtained in the manner described above is on the vector represented by the intermediate vector data is checked by comparing the value of the x-coordinate with xₛ₁ and xₑ₁ (step S22). When xₛ₁<x≦xₑ₁ is not satisfied, that there is no intersection is determined and the calculation is ended (step S24). When xₛ₁<x≦xₑ₁ is satisfied, that there is an intersection is determined and the x coordinate and the y coordinate obtained in the manner described above are obtained.

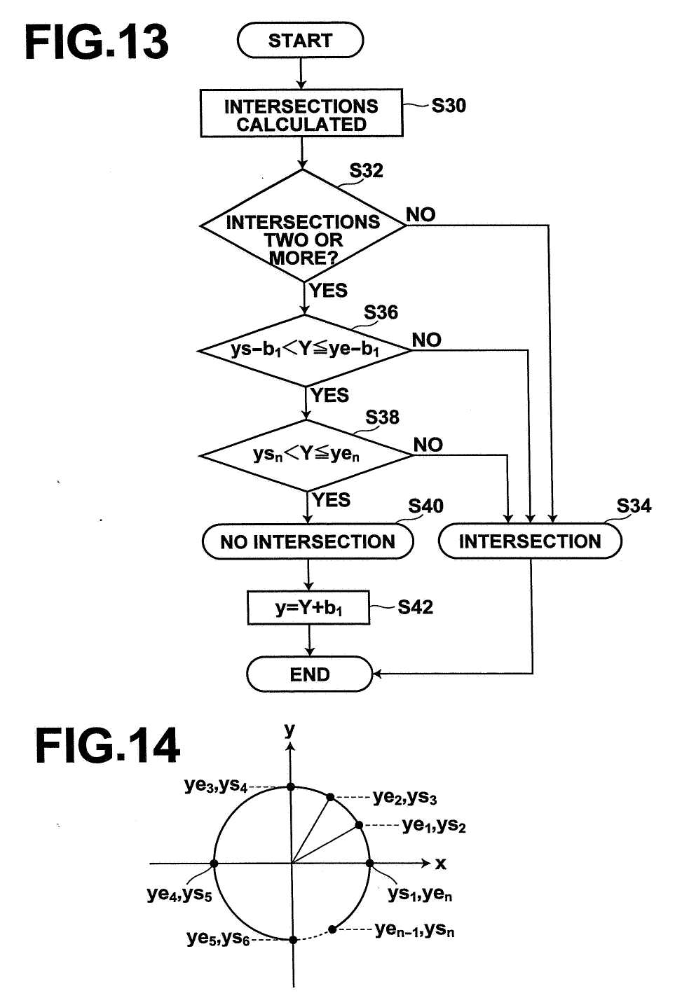

When the vectors represented by the intermediate vector data are curved lines (circular segment) represented by the following formula (3) and the exposing spot data loci are line segments represented by the following formula (4). A method of calculating the intersection arrangement data in this case will be described with reference to the flow chart shown in FIG. 13.

(x−a₁)²+(y−b₁)²=c² (3)

x=a₂y+b₂, xₛ≦x≦xₑ, yₛ≦y≦yₑ (4)

As shown in the flowchart shown in FIG. 13, the intersections of these segments are first calculated based on the above formula (3) and the above formula (4) (step S30). Here, after the formulae (3) and (4) are converted to the following formulae (5) and (6) which have the origin on the center of the circle, the intersections (X,Y) of these segments are calculated. When it is assumed that X=x−a₁, Y=y−b₁, the above formula (3) may be converted to

X²+y²=c² (5)

and the above formula (4) may be converted to

X=a₂Y+d, d=b₂+a₂b₁−a₁, xₛ−a₁≦X≦xₑ−a₁, yₛ−b₁≦Y≦yₑ−b₁ (6)

When the number of the intersections obtained by the above formulae (5) and (6) is 0 or 1, it is determined that there is no intersection and the calculation is ended (step S34). A point of contact is not counted as an intersection, here. When the number of intersections is not smaller than 2, whether the intersection obtained in the manner described above is on the exposing spot data loci is checked by comparing the value of they coordinate with (yₛ−b₁) and (yₑ−b₁) (step S36). When yₛ−b₁<y≦yₑ−b₁ is not satisfied, that there is no intersection is determined and the calculation is ended. (step S34) When yₛ−b₁<y≦yₑ−b₁ is satisfied, that there is an intersection is determined and whether the intersection obtained in the manner described above is on a circular segment of the circle represented by the above formula (5) is checked by comparing the value of the y coordinate with yₛₙ and yₑₙ (Nn stands for a natural number not smaller than 1. The yₛₙ and yₑₙ indicates a range of the values of y coordinates of the respective circular segments in the quadrant when the circular segment is divided by the quadrants as shown in FIG. 14. When yₛₙ<y≦yₑₙ is not satisfied, that there is no intersection is determined and the calculation is ended (step S34). Whereas when yₛₙ<y≦yₑₙ is satisfied, it is determined that an intersection is on a circular segment of the circle represented by the above formula (5) (step S40). Whereas when it is determined in step S38 that there is an intersection, the value of the y coordinate of the intersection is obtained by returning the y coordinate to the original coordinate system by calculating the following formula (7) (step S42).

y=Y+b₁ (7)

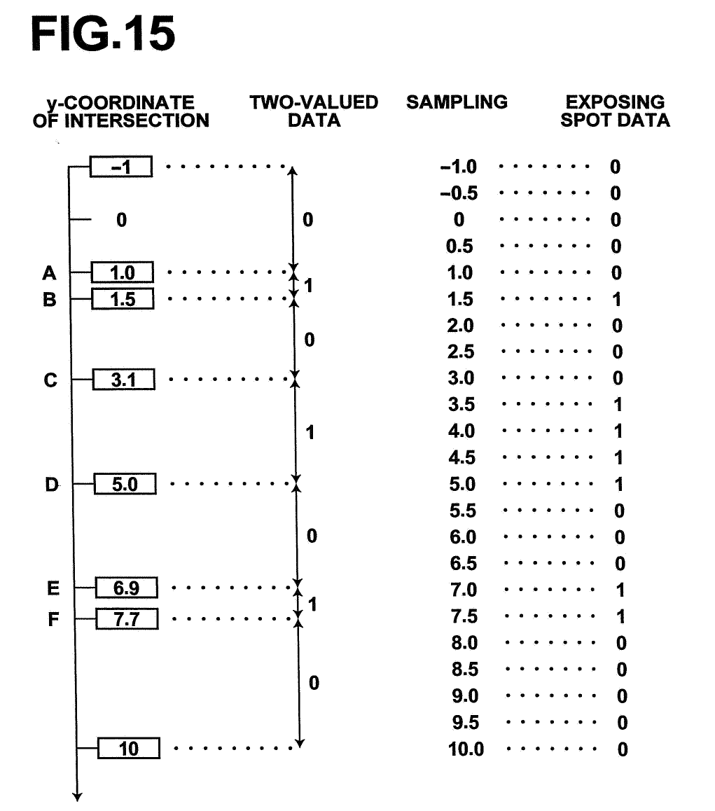

Then the y coordinates of the intersections A to F are output to the exposing spot data obtaining means 58, and in the exposing spot data obtaining means 58, an exposing spot data train for each micro mirror 38 is obtained based on the input y coordinates of the intersections. Specifically, the exposing spot data obtaining means 58 plots the y coordinates of the intersections A to F, and pieces of two-valued exposing spot data actual allotted based on the plotted y coordinates as shown in FIG. 15. The value of the y coordinate (−1) in FIG. 15 is the y coordinate of the position corresponding to the initial position of the micro mirror 38.

Further, the space between −1 to 10 in the y coordinate is parted at pitches of 0.5 as shown in FIG. 15 to sample the two-valued image data between −1 to 10 in the y coordinate at pitches of 0.5 to obtain the exposing spot data train for the micro mirror 38 such as shown in FIG. 15. Note that there are cases in which the pitch is not constant, as will be described later.

In a similar manner, the exposing spot data train for each micro mirror 38 is obtained and output to the exposure head control portion 59.

While the exposing spot data train for each micro mirror 38 is output to the exposure head control portion 59, the movable stage 14 is moved upstream at a desired speed from the downstream position shown in FIG. 1.

When the leading end of the substrate 12 is detected by the cameras 26, the exposure is begun. That is, the control signal is output to the DMD 36 of each exposure head 30 from the exposure head control portion 59 based on the exposing spot data, and the exposure head 30 turns on and off the micro mirrors of the DMD 36 to expose the substrate 12 based on the input control signal.

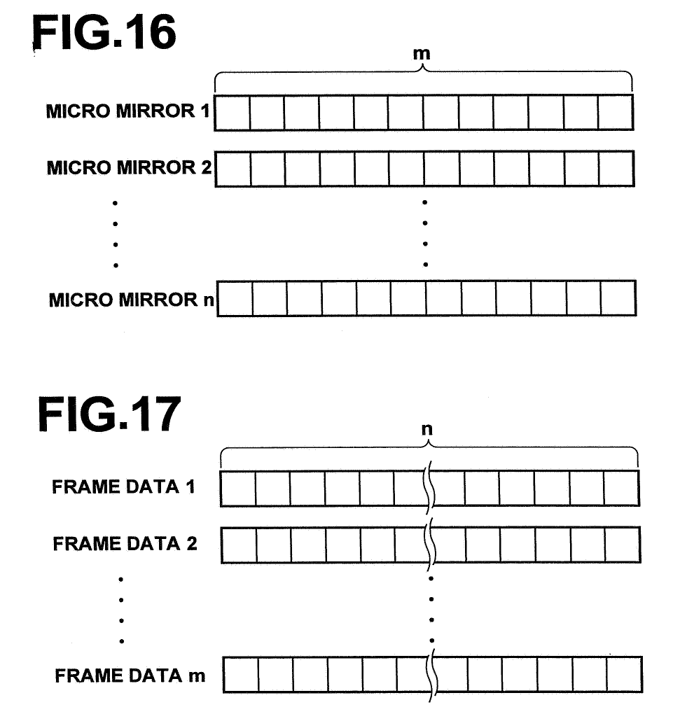

When the control signal is output to the exposure head 30 from the exposure head control portion 59, the control signals corresponding to positions of the exposure head 30 with respect to the substrate 12 are output in sequence with movement of the movable stage 14. At this time, as shown in FIG. 16, for instance, pieces of exposing spot data according to positions of the exposure head 30 may be read out and output to the DMD 36 of each exposure head 30 in sequence one by one from the exposing spot data train comprising m pieces of exposing data obtained for each micro mirror 38 or after carrying out a 90°-rotation or a conversion using a matrix on the obtained exposing spot data train as shown in FIG. 16, pieces of frame data 1 to m according to positions of the exposure head 30 with respect to the substrate 12 may be generated as shown in FIG. 17 and the frame data 1 to m may be output to the exposure head 30 in sequence.

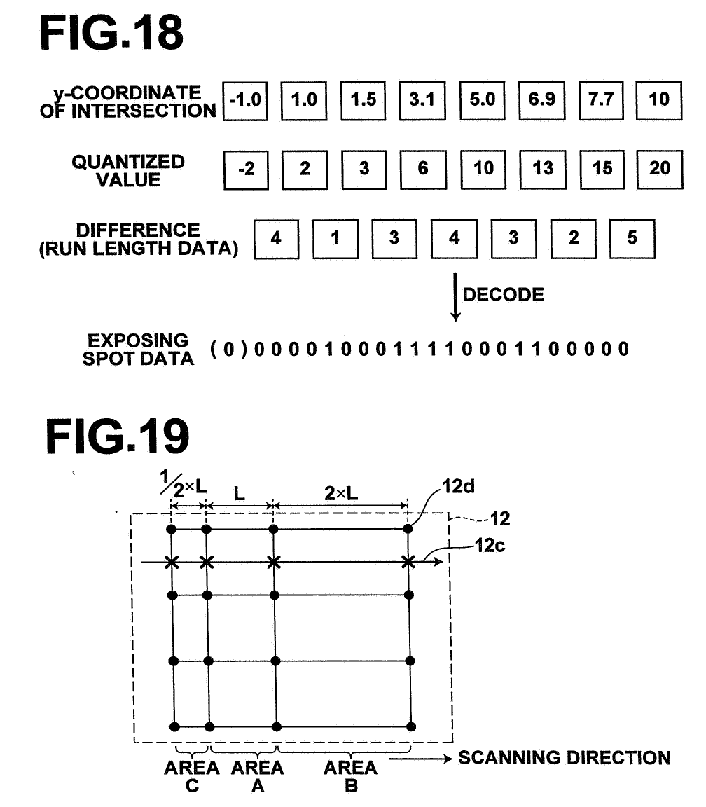

In the first embodiment described above, the method of obtaining the exposing spot data by the exposing spot data obtaining means 58 need not be limited to the method described above but, for instance, the exposing spot data train may be obtained by after dividing the values of the y coordinates of the intersections by 0.5, the sampling pitches, converting them into integers to obtain quantized values, and decoding differences between adjacent quantized values considering them to be run length data as shown in FIG. 18. When the exposing spot data train is obtained in the manner described above, the exposing spot data train similar to that shown in FIG. 15 by attaching 0 data corresponding to the initial position of the micro mirror to the top of the exposing spot data.

Though a method of obtaining the exposing spot data which is used upon exposing an image on the substrate 12 which has been deformed due to the press step or the like in the above description, a method similar to that described above may be used to obtain the exposing spot data in the case of a substrate which has not been deformed and is ideal in shape. The same applies to cases in which deformation of the substrate need not be considered. In these cases, intersections between the contour vector and the exposing spot data loci are obtained, based on the exposure loci on the substrate 12.

When the substrate 12 has been expanded or contracted in the scanning direction as shown in FIG. 19, the exposing spot data sampling pitches in the exposing spot data obtaining means 58 may be changed according to the degree of the expansion/contraction. Specifically, when the substrate 12 has been expanded or contracted as described above and the relation between the detected positional information 12d and the passing position information 12c is as shown in FIG. 19 so that area A where the space between pieces of the detected positional information 12d adjacent to each other in the scanning direction is an ideal (L), area B where the space is increased to 2L and area C where the space is reduced to L/2 mingle each other, the sampling pitches may be 0.5 (equal to the normal sampling pitches) in the area A, may be 0.25 (½ of the normal sampling pitches) in the area B and may be 1.0 (the double of the normal sampling pitches) in the area C. Though a method of obtaining the exposing spot data when the substrate 12 has been expanded or contracted in the scanning direction is only described in the above description, the sampling pitches may be changed according to the degree of the expansion/contraction in the similar manner when the substrate 12 has been deformed in other directions and the length of the passing position information 12c differs depending on the areas parted by the detected positional information 12d. By changing the sampling pitches according to expansion and contraction of the substrate 12, a desired image can be exposed in a desired position on the substrate 12.

Though the exposing light locus information is obtained in the exposing light locus information obtaining means 54 based on the reference mark positional information and the detected positional information in the above embodiment, it is not necessary to obtain the exposing light locus information taking into account the deformation of the substrate 12. For example, in the exposing light locus information obtaining means 54, the passing position information set in advance depending on the position of installment of each exposure head 30 with respect to the position of installment of the substrate 12 may be obtained as the exposing light locus information while the passing position information is output to the intersection arrangement data calculating means 56, where the intersections between the passing position information and the vectors represented by the intermediate vector data are calculated, and the exposing spot data is obtained based on the y coordinate in the manner similar to the method as described above. In this case, it is unnecessary to provide the reference mark 12a. Further, it is unnecessary to provide the reference mark 12a shown in FIG. 1 also in the following embodiment when not used. Positional displacement of the substrate 12 may be obtained, for example, by detecting the edges of the substrate 12.

An exposure system 20 employing a second embodiment of the present invention will be described in detail next. The exposure system 20 is substantially the same as that 10 employing a first embodiment of the present invention shown in FIG. 1 in appearance.

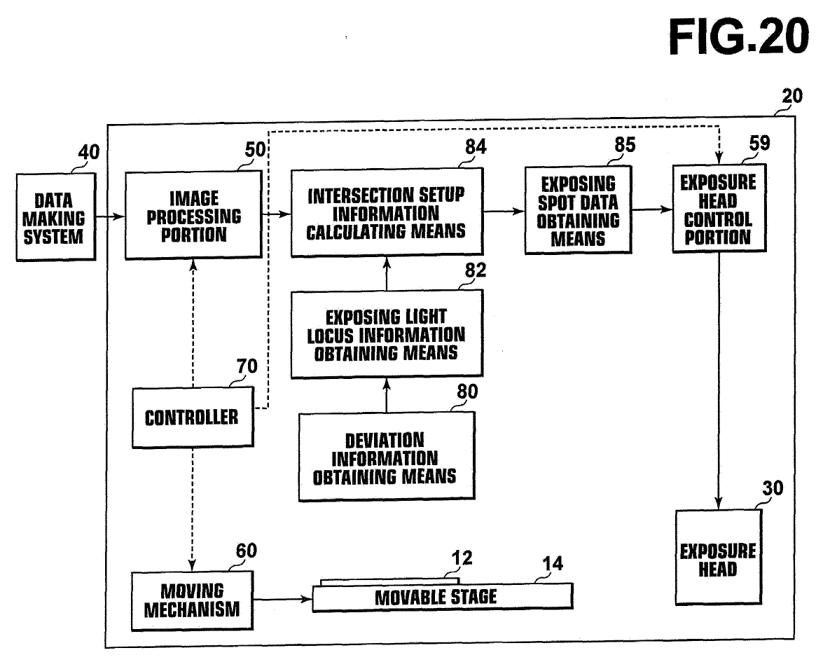

As shown in FIG. 20, the exposure system 20 comprises an intermediate vector generating means 50, a deviation information obtaining means 80 which obtains information on deviation of the movable stage 14 in a direction perpendicular to the direction of stage movement, an exposing light locus information obtaining means 82 which obtains information on exposing light loci of each micro mirror 38 on the substrate 12 based on the information on deviation of the movable stage 14 obtained by the deviation information obtaining means 80, an intersection arrangement data calculating means 84 which calculates intersection arrangement data representing setup of intersections of the exposing light loci information on the intermediate vector data corresponding to the information on exposing light loci and the vectors represented by the intermediate vector data based on information on exposing light loci of each micro mirror 38 on the substrate 12 obtained by the exposing light locus information obtaining means 82 and the intermediate vector data output from the intermediate vector generating means 50, an exposing spot data obtaining means 85 which obtains exposing spot data for each micro mirror 38 based on the intersection arrangement data obtained by the intersection arrangement data calculating means 84, an exposure head control portion 59, a moving mechanism 60 and a controller 70 which controls the overall exposure system of this embodiment. The elements having the reference numerals the same as those in FIG. 5 in FIG. 20 are the same in operations as those in the exposure system 10 of the first embodiment of the present invention.

Operation of the exposure system 20 will be described next with reference to the drawings.

Operation of the exposure system 20 up to the step of outputting intermediate vector data to the intersection arrangement data calculating means 84 is the same as that described above.

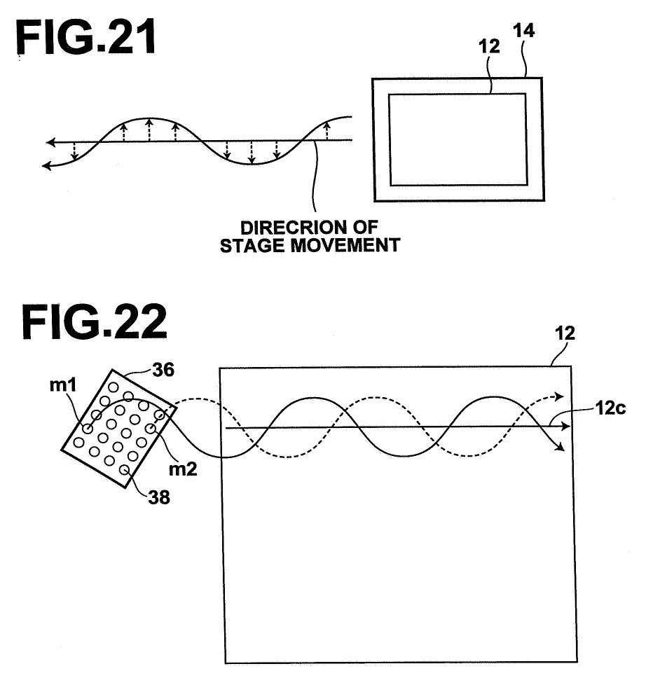

Then, information on deviation of the movable stage 14 in a direction perpendicular to the direction of stage movement is obtained by the deviation information obtaining means 80. The information on deviation means deviation of the direction of the actual movement of the movable stage 14 with respect to the direction of the stage movement of thereof (direction of the predetermined relative movement) as shown in FIG. 21. Specifically, the information on deviation is obtained by obtaining at predetermined spaces deviation of the locus of the actual movement of the movable stage 14 in the direction perpendicular to the stage movement direction with respect to the direction of preset locus of the movement of the movable stage 14 as shown in FIG. 21. Directions and lengths of the arrows shown by the broken line in FIG. 21 represent the deviation.

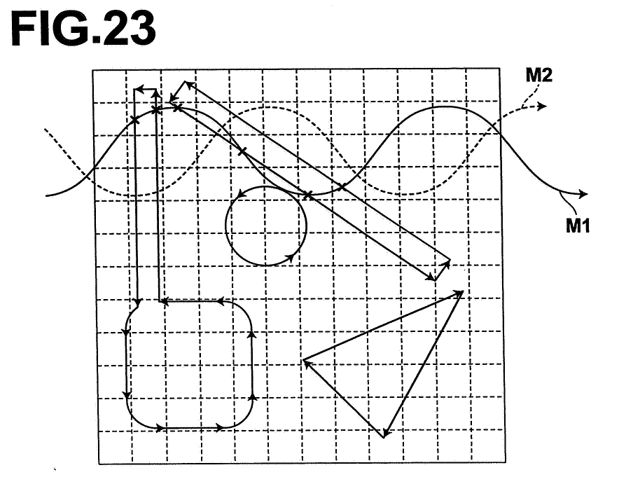

When there is a deviation in the locus of movement of the movable stage 14, the actual locus of the exposing light of each micro mirror 38 on the substrate 12 upon real exposure deviates according to the above deviation from the preset passing position information 12c of each micro mirror 38 as shown in FIG. 22. Accordingly, it is necessary to obtain exposing spot data corresponding to the real exposing light loci of each micro mirror 38. Though the micro mirrors m1 and m2 should pass the same position on the substrate 12, the real exposing light loci thereof will deviate in the phase thereof as shown in FIG. 22. Accordingly, it is necessary to obtain the exposing spot data taking into account the deviation in the phase.

In the exposure system 20, the exposing spot data is obtained according to the deviation of the exposing light loci of the micro mirrors 38. Specifically, deviation of the movable stage 14 is measured in advance, and the measured deviation is obtained by the deviation information obtaining means 80. The deviation information obtaining means 80 outputs the obtained deviation to the exposing light locus information obtaining means 82. As a method of measuring the deviation, for instance, a method using a laser beam which is employed in an IC wafer stepper system may be employed. For example, while a reflecting surface extending in the direction of stage movement is provided on the movable stage 14 and at the same time a laser to radiate a laser beam toward the reflecting surface and a detecting portion which detects the reflected light reflected at the reflecting surface are provided, the deviation can be measured by detecting in sequence with movement of the movable stage 14 the phase shift of the reflected light with the detecting portion.

In the exposing light locus information obtaining means 82, the passing position information 12c of each micro mirror 38 has been set and the exposing light locus information obtaining means 82 obtains information on exposing light loci of each micro mirror 38 on the substrate 12 upon exposure based on the input information on deviation of the movable stage 14 and the passing position information 12c of each micro mirror 38. The passing position information 12c is the same as that in the exposure system 10 employing the first embodiment of the present invention.

The information on exposing light loci of each micro mirror 38 on the substrate 12 is output to the intersection arrangement data calculating means 84 and the intersection arrangement data calculating means 84 plots the input information on exposing light loci on the coordinate system the same as that of the intermediate vector data as the loci of the exposing spot data as shown in FIG. 23 to obtain information on the arrangement of the intersections of the vectors represented by the intermediate vector data and the loci of the exposing spot data as in the same manner as in the first embodiment. The method of calculating the information on the arrangement of the intersections is the same as described above.

The exposing spot data locus M1 in FIG. 23 is the exposing spot data locus m1 of the micro mirror shown in FIG. 22 and the exposing spot data locus M2 in FIG. 23 is the exposing spot data locus m2 of the micro mirror shown in FIG. 22.

Then the values of the y coordinates of the information on the arrangement of the intersections obtained in the manner described above are output to the exposing spot data obtaining means 85 and in the exposing spot data obtaining means 85, exposing spot data train of each micro mirror 38 is obtained based on the input y coordinates. The method of obtaining the exposing spot data train is the same as described above.

The exposing spot data train of each micro mirror 38 is output to the exposure head control portion 59.

At the same time, the movable stage 14 is moved upstream at a desired speed from the downstream position shown in FIG. 1.

When the leading end of the substrate 12 is detected by the cameras 26, the exposure is began. That is, the control signal is output to the DMD 36 of each exposure head 30 from the exposure head control portion 59 based on the exposing spot data, and the exposure head 30 turns on and off the micro mirrors of the DMD 36 to expose the substrate 12 based on the input control signal.

An exposure system 30 employing a third embodiment of the present invention will be described in detail next.

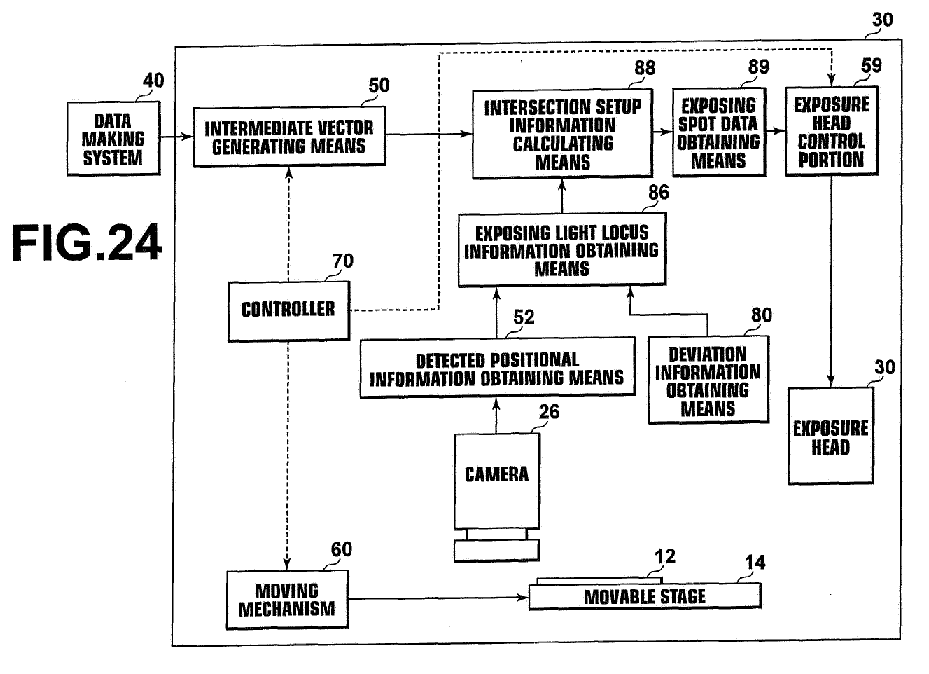

The exposure system 30 doubles the exposure system 10 employing the first embodiment of the present invention and the exposure system 20 employing the second embodiment of the present invention as shown in FIG. 24.

In the exposure system 30, the detected positional information of the reference 12a obtained by the detected positional information obtaining means 52 and the information on deviation of the movable stage 14 obtained by the deviation information obtaining means 80 are input into an exposing light locus information obtaining means 86.

The exposing light locus information obtaining means 86 obtains exposing light locus information representing the actual loci of the exposing light on the substrate 12 (actual exposing light loci in an imaging space above the substrate) of each micro mirror 38 based on the input positional information and the deviation information described above.

Specifically, in the exposing light locus information obtaining means 86, the values of the coordinates of the intersections of a straight line joining pieces of the detected positional information 12d adjacent to each other in the direction perpendicular to the scanning direction and a straight line representing the passing position information 12c of each micro mirror 38 are obtained as in the first embodiment and the distances between the intersections and the pieces of detected positional information 12d adjacent thereto in the direction perpendicular to the scanning direction are obtained and the ratio of the distance between one of the pieces of detected positional information 12d adjacent thereto in the direction perpendicular to the scanning direction of each intersection and the distance between the other of the pieces of detected positional information 12d adjacent thereto in the direction perpendicular to the scanning direction of the intersection is obtained.

The exposing light locus information obtaining means 86 obtains a temporary exposing light locus information on the substrate 12 of each micro mirror 38 such as shown by the curved line in FIG. 23 based on the input deviation and the passing position information 12c of each micro mirror 38 as in the second embodiment.

Then the exposing light locus information obtaining means 86 outputs the thus obtained ratios and the temporary exposing light locus information to an intersection arrangement data calculating means 88 as the exposing light locus information.

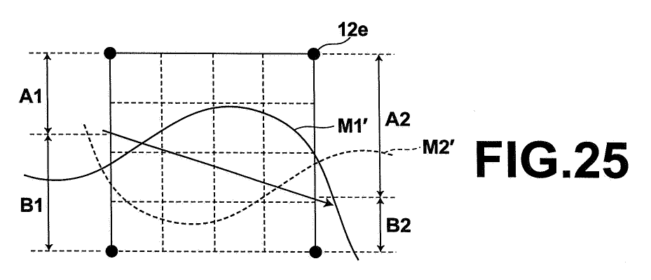

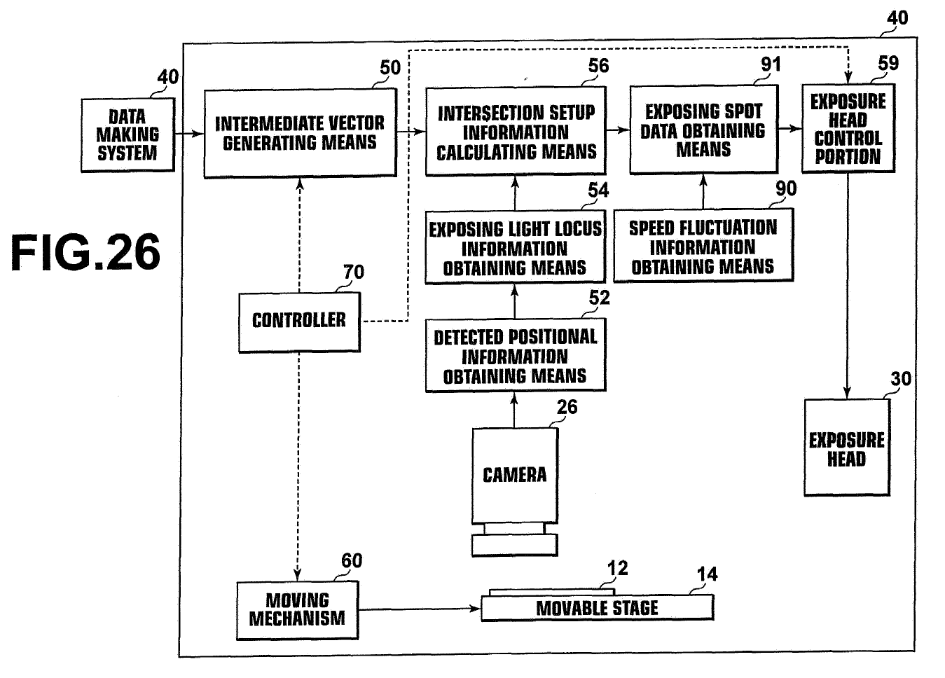

The intersection arrangement data calculating means 88, after obtaining points dividing straight lines joining pieces of image data reference position information 12e adjacent to each other in a direction perpendicular to the scanning direction based on the input ratio, obtains a straight line joining the points as shown in FIG. 25 as in the first embodiment, and then inclines the temporary exposing light locus information by the inclination of the straight line with respect to the scanning direction to obtain curves M1′ and M2′ representing the exposing light locus information. The curves M1′ and M2′ are obtained as the exposing spot information by the intersection arrangement data calculating means 88. A1:B1 and A2:B2 in FIG. 26 are ratios which satisfies a1:b1=A1:B1 and a2:b2=A2:B2 when the ratios input from the exposing light locus information obtaining means 86 are a1:b1 and a2:b2.

The exposing spot data information for each micro mirror is obtained in the same manner as described above.

Then the intersection arrangement data calculating means 88 plots the exposing spot data information obtained in the manner described above on the coordinate system the same as that of the intermediate vector data as in the same manner as described above to obtain information on the arrangement of the intersections of the vectors represented by the intermediate vector data and the loci of the exposing spot data. The method of calculating the information on the arrangement of the intersections is the same as described above.

Then the values of the y coordinates of the information on the arrangement of the intersections obtained in the manner described above are output to the exposing spot data obtaining means 89 and in the exposing spot data obtaining means 89, exposing spot data train of each micro mirror 38 is obtained based on the input y coordinates. The method of obtaining the exposing spot data train is the same as described above.

The exposing spot data train of each micro mirror 38 is output to the exposure head control portion 59.

At the same time, the movable stage 14 is moved upstream at a desired speed from the downstream position shown in FIG. 1.

When the leading end of the substrate 12 is detected by the cameras 26, the exposure is began. That is, the control signal is output to the DMD 36 of each exposure head 30 from the exposure head control portion 59 based on the exposing spot data, and the exposure head 30 turns on and off the micro mirrors of the DMD 36 to expose the substrate 12 based on the input control signal.

An exposure system 40 employing a fourth embodiment of the present invention will be described in detail next. The exposure system 40 is substantially the same as that 10 employing the first embodiment of the present invention shown in FIG. 1 in appearance.

As shown in FIG. 26, the exposure system 40 further comprises a exposing spot data obtaining means 91 which obtains in advance information on the fluctuation in speed of movement of the substrate 12 in addition to the structure of the exposure system 10 employing the first embodiment of the present invention shown in FIG. 1. An exposing spot data obtaining means 91 shortens the sampling pitches as the speed of movement of the movable stage 14 becomes lower based on the information on the fluctuation in speed of movement of the substrate 12 obtained by the speed fluctuation information obtaining means 90. In FIG. 26, the elements given the same reference numerals as in FIG. 5 are the same in operation as the exposure system 10 employing the first embodiment of the present invention shown in FIG. 1. In this embodiment, “information on the fluctuation in speed of movement of the substrate 12” means unevenness of the speed of movement according to accuracy in control of the moving mechanism 60 of the movable stage 14.

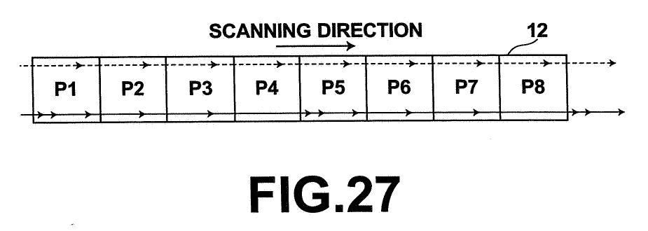

FIG. 27 is a view showing the exposing light locus on the substrate 12 of a predetermined micro mirror 38 and an exposure timing when the exposing spot is exposed by the micro mirror 38 upon the real exposure. The broken line arrows in FIG. 27 show the exposing light locus of the micro mirror 38 and the exposure timing when there is no fluctuation in speed of movement of the movable stage 14, while the solid line arrows show the exposing light locus of the micro mirror 38 and the exposure timing when there is fluctuation in speed of movement of the movable stage 14. Further, the parts on the straight line attached with arrows show the timing at which the exposing spot is to be exposed by the micro mirror 38. Though a pair of exposing light loci are shown by a pair of straight lines in FIG. 27 for the purpose of convenience of description, the exposing light loci are of the same micro mirror. P1 to P8 in FIG. 27 denotes pixels of the image to be exposed on the substrate 12. The exposure timing and the speed of movement of the movable stage 14 are set in advance to have a relative reference so that the image is exposed on the substrate 12 at a desired resolution.

As shown in FIG. 27, each of the pixels P1 to P8 is exposed in a exposing spot unless the fluctuation in speed of movement of the movable stage 14. That is, the number of the exposing spot which the micro mirror 38 exposes for one pixel is 1.

Whereas when there is fluctuation in speed of movement of the movable stage 14, the number of the exposing spots exposing the pixels P1 to P8 changes depending upon the speed of movement. That is, when the exposure timing is two or more during movement of the movable stage 14 by one pixel, i.e., an area over which the movable stage 14 is moved relatively slowly, each pixel is exposed by two or more exposing spots. When no exposure timing is during movement of the movable stage 14 by one pixel, i.e., an area over which the movable stage 14 is moved relatively rapidly, each pixel is not exposed.

In FIG. 27 when Pixels P1 and P5 are to be exposed, the movable stage 14 is moved relatively slowly, when Pixels P4 and P8 are to be exposed, the movable stage 14 is moved relatively rapidly, and when Pixels P2 and P3 and P6 and P7 are to be exposed, the movable stage 14 is moved at a constant speed set in advance.

Accordingly, it is necessary to obtain the exposing spot data according to fluctuation in speed of movement of the movable stage 14.

The exposing spot data obtaining means 91 changes the sampling pitches so that pieces of the exposing spot data which is according to the information on the fluctuation in speed obtained by the speed fluctuation information obtaining means 90 in number can be obtained. The “information on the fluctuation in speed” specifically means, for instance, information on fluctuation in the distance by which the movable stage 14 is moved in the direction of the stage movement at a predetermined exposure pitch and is set in advance in the speed fluctuation information obtaining means 90.

The information on the fluctuation in speed which has been set in advance in the speed fluctuation information obtaining means 90 is output to the exposing spot data obtaining means 91, and the exposing spot data obtaining means 91 makes the sampling pitch 0.5 (equal to the normal sampling pitches) when there is no speed fluctuation in movement of the movable stage 14, and makes the sampling pitch according to speed fluctuation in movement of the movable stage 14 when there is speed fluctuation in movement of the movable stage 14. For example, when there is speed fluctuation in movement of the movable stage 14 shown by the solid line in FIG. 27, the exposing spot data obtaining means 91 shortens the sampling pitch so that three pieces of the exposing spot data may be obtained when obtaining the exposing spot data for exposing the pixels P1 and P5. When obtaining the exposing spot data for exposing the pixels P4 and P8, the exposing spot data obtaining means 91 elongates the sampling pitch so that no piece of the exposing spot data may be obtained. Whereas, when obtaining the exposing spot data for exposing the Pixels P2 and P3 and P6 and P7, the exposing spot data obtaining means 91 makes the sampling pitch normal so that one piece of the exposing spot data may be obtained.

The pieces of the exposing spot data thus obtained are output to the exposure head control portion 59 in sequence with movement of the movable stage 14 and the control signal according to the exposing spot data is output to the micro mirrors 38 of each exposure head 30 from the exposure head control portion 59. The micro mirrors 38 are turned on/off in response to the control signals and the exposing points are exposed to the substrate 12.

In the exposure system 40 of the fourth embodiment, operation up to the steps of obtaining the intersections of the exposing spot data loci and the vectors represented by the intermediate vector data and allotting two-valued image data to the y-coordinates of the intersections after the detected positional information is obtained by the detected positional information obtaining means 52, the exposing light locus information is obtained by the exposing light locus information obtaining means 54 based on the detected positional information and the exposing spot data loci are obtained in the intersection arrangement data calculating means 56 based on the exposing light locus information is the same as that in the exposure system 10 of the first embodiment. When sampling the thus allotted two-valued image data to obtain the exposing spot data, the method described above may be employed.

The exposing spot data can be obtained also in exposure systems of the second and third embodiments in a method similar to that described above. Also in such a case, operation up to the step of allotting pieces of the two-valued image data to the y-coordinates of the intersections of the exposing spot data loci and the vectors represented by the intermediate vector data is the same in that described above in conjunction with the exposure systems of the second and third embodiments.

In the exposure system of the second embodiment, by changing the number of pieces of the exposing spot data to be obtained according to the speed fluctuation information as in the fourth embodiment, not only snaking of the movable stage 14 can be corrected but also correction can be made taking into account the yawing of the movable stage 14. “Yawing” is rotation of the movable stage 14 added to the snaking thereof. Since, by the rotation of the movable stage 14, the position of an image of each micro mirror 38 on the substrate 12 changes and at the same time, the distance by which the movable stage 14 is moved at a predetermined exposure timing pitch changes, that is, since local speed fluctuation of the movable stage 14 is generated by the rotation, the number of pieces of the exposing spot data to be obtained is changed according to information on fluctuation of the position of an image of each micro mirror 38 on the substrate 12 and on fluctuation of the stage movement speed. Further, it is possible to take into account only the component of rotation with the component of snaking considered to be 0.

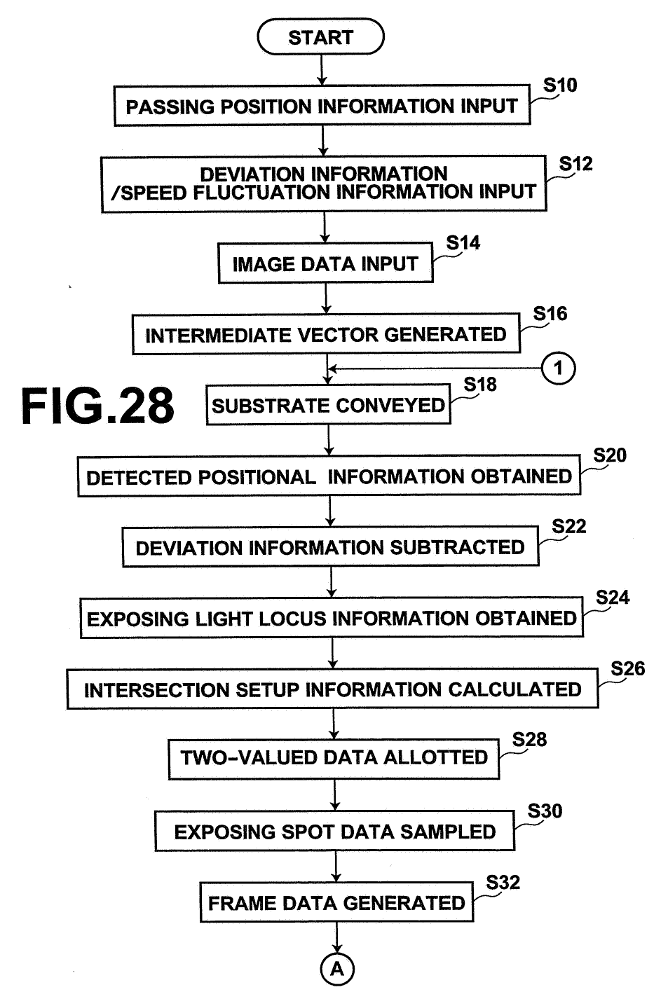

An exposure system may have all the first to fourth embodiments. Operation of an exposure system so arranged will be briefly described with reference to the flow chart shown in FIGS. 28 and 29.

The passing position information of each micro mirror 38 of the DMDs 36 of each exposure head 30 is input into the exposing light locus information obtaining means 54 (step S10), and the position deviation information and the speed fluctuation information of the movable stage 14 are respectively input into the position deviation information obtaining means 80 and the speed fluctuation information obtaining means 90 (step S12). The vector format image data generated by the data making system 40 is input into the intermediate vector generating means 50 (step S14), and the intermediate vector data is generated based on the image data in the intermediate vector generating means 50, and the intermediate vector data is output to the intersection arrangement data calculating means 56 (step S16).

While the intermediate vector data is generated as described above, the controller 70 outputs the control signal to the moving mechanism 60, and the moving mechanism 60 once moves the movable stage 14 upstream along the guides 20 from the position shown in FIG. 1 and then moves the same in the direction of movement of the movable stage 14 at a desired speed in response to the control signal (step S18).

The reference marks 12a on the substrate 12 on the movable stage 14 moved as described above are photographed by cameras 26, and the detected positional information is obtained by the detected positional information obtaining means 52 based on the photographed image data (step S20).

The detected positional information is output to the exposing light locus information obtaining means 54 from the detected positional information obtaining means 52 and at the same time, the position deviation information set in the deviation information obtaining means is output to the exposing light locus information obtaining means 54. The information on the exposing light locus of each micromirror 38 on the substrate 12 is calculated. Specifically, the values of the coordinates of the intersections of a straight line joining pieces of the detected positional information 12d adjacent to each other in the direction perpendicular to the scanning direction and a straight line represented by the passing position information 12c of each micro mirror 38 are obtained and the detected positional information 12d adjacent thereto in the perpendicular direction are obtained and the ratio of the distance between one of the pieces of detected positional information 12d adjacent thereto in the direction perpendicular to the scanning direction of each intersection and the distance between the other of the pieces of detected positional information 12d adjacent thereto in the direction perpendicular to the scanning direction of the intersection is obtained as described above in the exposure system 10 of the first embodiment. Specifically, a1:b1, a2:b2, a3:b3 and a4:b4 in FIG. 9 are obtained as the exposing light locus information. The above ratios are obtained after the deviation is subtracted from the detected positional information obtained in the manner described above (step S22).

In the exposing light locus information obtaining means 54, the above ratios are obtained, and at the same time, the temporary exposing light locus information is obtained based on the input deviation and the passing position information 12c of each micro mirror 38, and the thus obtained ratios and the temporary exposing light locus information are output to the intersection arrangement data calculating means 56 as the exposing light locus information. The order in which the ratios and the temporary exposing light locus information are obtained may be reversed. In the intersection arrangement data calculating means 56, curves representing the exposing spot data locus corresponding to the exposing light locus information are obtained as described above in conjunction with FIG. 25 (step S24), and the exposing spot data loci obtained in the manner described above are plotted on the coordinate system the same as that of the intermediate vector data as in the same manner as described above to obtain information on the arrangement of the intersections of the vectors represented by the intermediate vector data and the loci of the exposing spot data (step S26). The method of calculating the information on the arrangement of the intersections is the same as described above.

Then the values of the y coordinates of the information on the arrangement of the intersections obtained in the manner described above are output to the exposing spot data obtaining means 58 and the two-valued image data is allotted based on the y coordinates (step S28).

In the exposing spot data obtaining means 58, the speed fluctuation information obtained by the speed fluctuation information obtaining means 90 is input and as described above in the exposure system of the fourth embodiment, the sampling pitch according to the speed fluctuation information is set, and the two-valued image data is sampled at the sampling pitch to obtain the exposing spot data train for each micro mirror 38 (step S30). The method of obtaining the exposing spot data train is the same as described above.

It is preferred that the sampling pitch be determined at this time taking into account not only the speed fluctuation information but also expansion or contraction of the substrate 12 in the scanning direction (that is, the length of the passing position information of the micro mirror 38 for each area on the substrate 12 parted by pieces of the detected positional information 12d.

A 90°-rotation or a conversion using a matrix is carried out on the thus obtained exposing spot data train for each micro mirror 38, pieces of frame data 1 to m according to positions of the exposure head 30 with respect to the substrate 12 are generated as shown in FIG. 17 (step S32).

At the same time, the movable stage 14 is moved upstream at a desired speed from the downstream position shown in FIG. 1. When the leading end of the substrate 12 is detected by the cameras 26, the exposure is began and pieces of the frame data 1 to m are output in sequence according to positions of the exposure head 30 to each exposure head 30 with movement of the movable stage 14 to expose the image on the substrate 12 based on the frame data (step S34). When all the pieces of the frame data are input into the exposure head 30 and the exposure is ended, the movable stage 14 is moved upstream again (step S36). When there is another substrate 12, processing from step S16 is repeated after the substrate is changed to said another one. Whereas when there is no another substrate 12, processing is ended (step S38).

According to the exposure systems of the first to fourth embodiments, since the vector format image data representing an image is obtained while information on the loci of the micro mirror 38 on the substrate 12 upon exposure of the image is obtained, information on the arrangement of the intersections of the contour of the image represented by the image data and the exposing spot data loci on the image data corresponding to the exposing light locus information is obtained and the exposing spot data corresponding to the exposing spot data loci is obtained based on the information on the arrangement of the intersections, the imaging spot data is directly obtained from the vector format image data, the imaging spot data can be directly obtained from the vector format image data without converting the vector format image data to the raster form image data as in the conventional, whereby the accuracy in drawing an image can be improved without deteriorating the processing speed or increasing the cost.

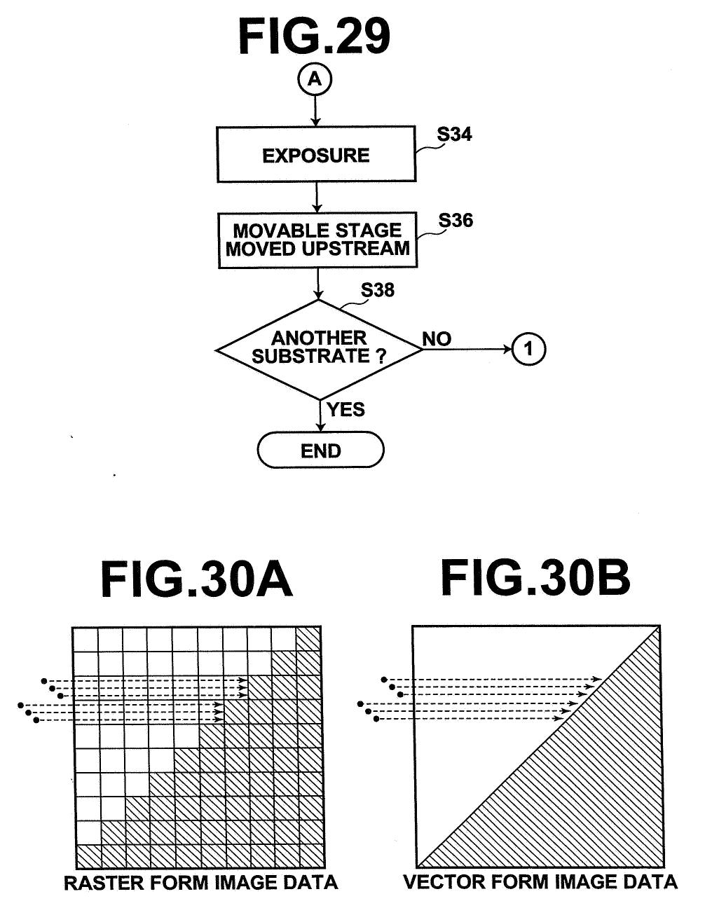

FIGS. 30A and 30B are schematic views visually showing the result of the exposure systems of the first to fourth embodiments described above. FIG. 30A shows an image exposed by the use of raster form image data whereas FIG. 30B shows an image exposed by the use of vector format image data. The black circles in FIGS. 30A and 30B indicate the micro mirrors and broken arrows indicate the correspondence of micro mirrors and pixels exposed by the micro mirrors.

When a plurality of the reference marks 12a which are provided in advance in predetermined positions on the substrate 12 are detected to obtain the detected positional information 12d and the exposing light locus information is obtained based on the obtained detected positional information 12d as in the exposure system of the first embodiment, even if the substrate 12 is deformed, image can be formed on the substrate 12 according to the deformation thereof since, by obtaining in advance the information on the exposing light loci of the micro mirror 38 on the substrate 12 after deformation, the exposing spot data corresponding to the information on the exposing light loci of the micro mirror 38 on the substrate 12 after deformation can be obtained from the image data. Accordingly, for instance, when a multiple-layered printed circuit board is to be formed, since the wiring pattern of each layer can be formed according to deformation of the layer, the wiring patterns of the respective layers can be located to each other at a high accuracy.

Further, when the information on deviation of direction of the actual movement of the substrate 12 upon image drawing from a predetermined relative movement direction of the substrate 12 is obtained, and the information on the exposing light loci is obtained based on the obtained deviation information as in the exposure system of the second or third embodiment described above, even if deviation is generated in the direction of movement of the substrate 12, since information on the exposing light loci according to the deviation can be obtained in advance and the exposing spot data corresponding to the information on the exposing light loci can be obtained from the image data, a desired image can be formed in a desired position on the substrate 12 without affected by the deviation in the direction of the movement.

When speed fluctuation information representing fluctuation in the actual movement of the substrate 12 upon image drawing with respect to a predetermined speed of relative movement of the substrate 12 is obtained, and exposing spot data is obtained while changing the sampling pitch so that the number of the exposing spot data increases in the imaging area where the actual movement of the substrate 12 is slower based on the obtained speed fluctuation information as in the exposure system of the fourth embodiment, a desired image can be exposed in a desired position on the substrate 12 without affected by the fluctuation in the speed of the movement.

Though, in the exposure systems of the first to fourth embodiments described above, the exposing spot data is obtained by causing the exposing spot data loci obtained according to, for instance, the deformation of the substrate 12 to correspond to the vector format image data, the image data may be deformed to correspond to the detected positional information, and the exposing spot data may be obtained based on the exposing spot data loci deformed similarly to the image data. Note that deviations may be classified into those which are compensated for by deforming the image data, and those which are compensated for by deforming the exposing spot data loci (including pitch components) according to the properties thereof. For example, deformations of the substrate and deviations in the position thereof can be compensated for by deforming the image data, while deviations in conveyance by the moving stage may be compensated for by deforming the exposing spot data loci. In this case, if deviations in conveyance by the moving stage are not considered, the exposing spot data loci are not deformed.

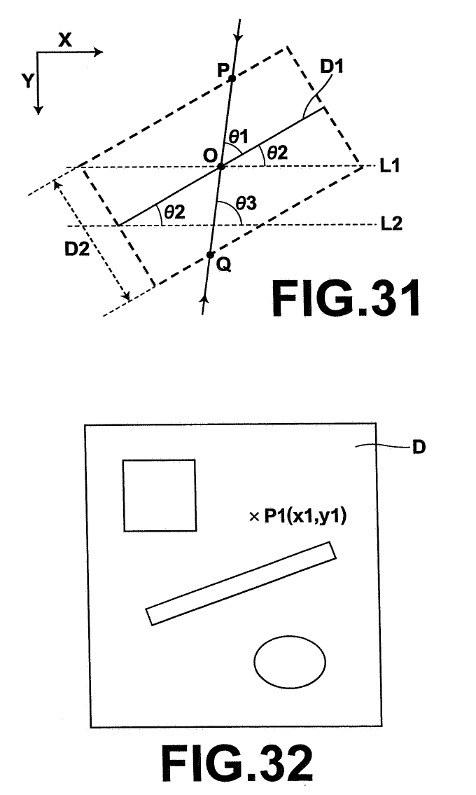

Further, though in the exposure systems of the first to fourth embodiments described above, the intermediate vector data is generated and the intersections of the exposing spot data loci and the contour of the image represented by the image data by the use of the intermediate vector data, it is not necessary to generate the intermediate vector data in order to obtain the above intersections. For example, when the vector format image data comprises segment data D1 representing the direction and length of a line segment and thickness' data D2 representing the thickness of the line segment as shown in FIG. 31, the intersection O of the exposing spot data locus shown by an arrow in FIG. 31 and the segment data D1 is first obtained and an angle θ1 is obtained according to the following formula (1). Based on the angle θ1, a length of OP is obtained from the following formula (2) and the coordinates of the intersection P can be obtained from the following formula (3) based on the length of OP. Further, the coordinates of the intersection Q can be obtained in a similar manner based on angles θ1, θ2 and θ3 and Qp, Ox and Oy. L1 and L2 in FIG. 31 denote straight lines parallel to the x-direction.

θ1=θ3ƒ2 (1)

OP=(D2/2)×(1/sin θ1) (2)

Px=Ox+OP×cos θ3, Py=Oy+OP×sin θ3 (3)

wherein Px represents the x-coordinate of the intersection P, Py represents the y-coordinate of the intersection P, Ox represents the x-coordinate of the intersection O, and Oy represents the y-coordinate of the intersection O.

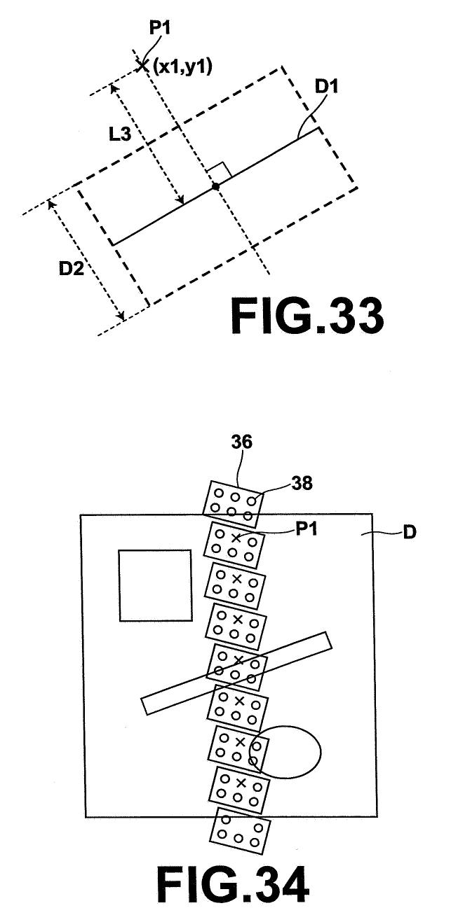

The method of obtaining the exposing spot data from the vector format image data need not be limited to those described above in conjunction with the first to fourth embodiments but may be other methods. For example, coordinates of a position (x1, y1) on the image data D corresponding to a position of the exposing spot P1 on the substrate 12 are obtained as shown in FIG. 32, and the exposing spot data for the exposing spot can be obtained based on the vector format image data D and the coordinates of a position (x1,y1). Specifically, when the vector format image data comprises segment data D1 representing the direction and length of a line segment and thickness data D2 representing the thickness of the line segment as shown in FIG. 33, the distance L3 between the exposing spot P1 and the segment D1 is obtained and whether the exposing spot P1 is on the image represented by the image data is determined by comparing L3 and D2/2. When it is determined that the exposing spot P1 is on the image, the value shown by the vector format image data may be obtained as the exposing spot data for the exposing spot P1. The value shown by the vector format image data need not be limited to a two-valued value but may be a multi-valued value. Whereas when it is determined that the exposing spot P1 is not on the image, 0 may be obtained as the exposing spot data for the exposing spot P1.

Coordinates of the exposing spot P1 may indicate the position of the micro mirror 38 on the substrate 12 at a predetermined position as shown in FIG. 34.

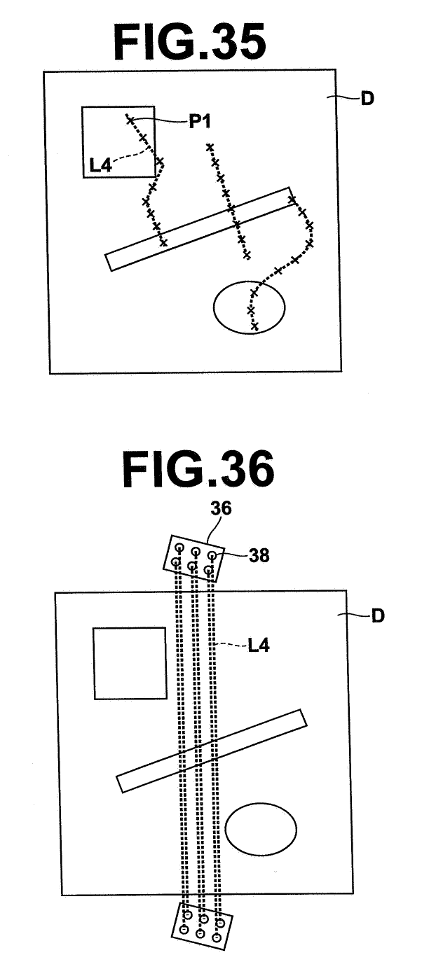

The exposing spot data may be obtained by superposing a plurality of images determined based on the image data D on the line L4 including the coordinates of position of the exposing spot P1 as shown in FIG. 35 and obtaining the exposing spot data based on the image data of the image where the line L4 overlaps the image.

The above line L4 may be an exposing light locus of the micro mirror 38 on the substrate 12 as shown in FIG. 36.

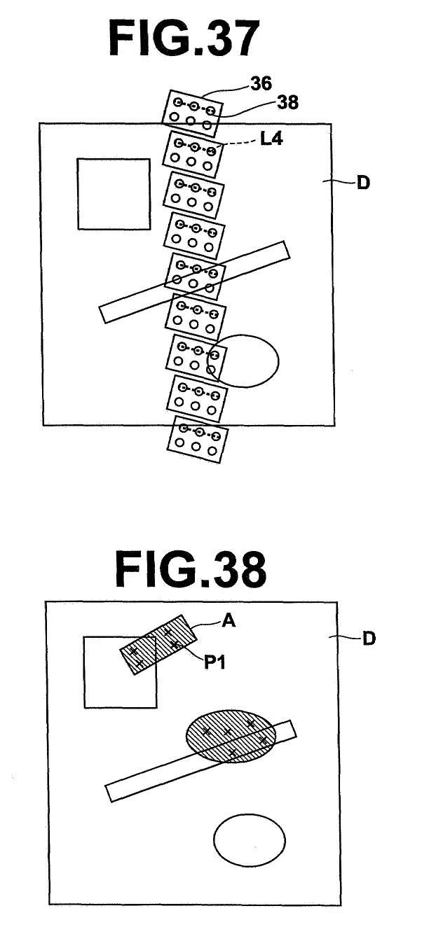

Further, the above line L4 may be a straight line joining the micro mirror 38 of the DMD 36 at a predetermined position on the substrate 12 as shown in FIG. 37. In this case, first, the positional coordinates of the starting point of a vector (for example, the positional coordinates of a single predetermined micro mirror) are obtained. Then, the intersections between a line that extends from the starting point and the contour vector of the exposure image data D are calculated. Thereafter, the exposing spot data are calculated for micromirrors between each of the intersections, or those included in other sections. The shape of the line may be set as a fixed value, based on the arrangement of the beam spots. Alternatively, the line may be deformed while taking into consideration deformation of the substrate or deviations in conveyance by the moving stage, in a manner similar to that of the exposing light loci.

Further, the exposing spot data may be obtained by superposing a plurality of images determined based on the image data D on a predetermined area A including the coordinates of position of the exposing spot P1 as shown in FIG. 38 and obtaining the exposing spot data based on the image data of the image where the predetermined area A overlaps the image.

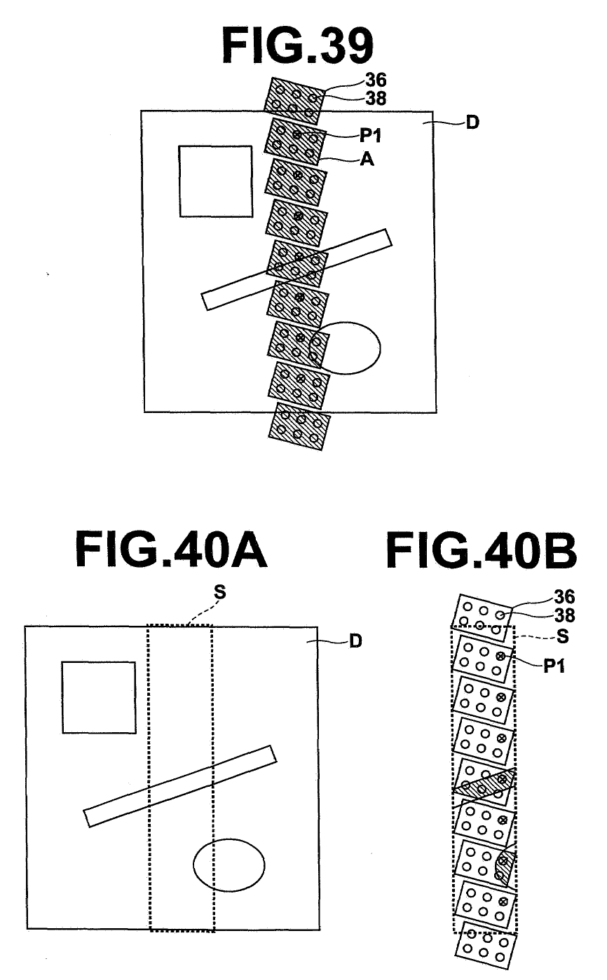

As shown in FIG. 39, the predetermined area A may be the area of the DMD 36 at a predetermined position on the substrate 12. For example, the region A may be set for the entirety of the image of the DMD 36, or for each portion of the DMD 36.

Further, a predetermined rectangular area S may be set at a predetermined position on the image data D as shown in FIGS. 40A and 40B while overlap of the area of the DMD 36 and the image is obtained in the rectangular area S, and the exposing spot data for the exposing spot P1 may be obtained based on the image data for the overlapping portion.

Though an exposure system comprising a DMD as the spatial light modulator element has been described in the above embodiments, a transmission type spatial light modulator element can be employed in addition to such a reflection type spatial light modulator element.

Though so-called a flood bed type exposure system has been described by way of example in the above embodiments, the present invention may be applied to so called an outer drum type exposure system provided with a drum around which a photosensitive material is wound.

The substrate 12 which is exposed by the above embodiments of the present invention need not be limited to a printed circuit board but may be, for instance, a substrate for a flat panel display. In this case, the pattern may be any structure, including but not limited to: a color filter, a black matrix, and a semiconductor circuit, such as a TFT. The substrate 12 may be either like a sheet or like a member in a continuous length (e.g., a flexible board) in its shape.

The method of and system for drawing an image of the present invention may be applied to drawing an image by a printer such as of an ink jet system. For example, an imaging dot by discharge of ink may be formed in the same manner as the present invention. That is, the imaging spot forming region in the present invention may be regarded as a region to which ink discharged from each nozzle of the printer of the ink jet system adheres.

Further, the locus information may be based on information on the locus of the spot forming region on the real substrate or information on approximation of the locus of the spot forming region on the real substrate or information on estimation of the locus of the spot forming region on the real substrate.

Similarly to that the loci of the light beam on the image data are defined by a nonlinear line such as a broken line or a curve according to deformation of the substrate or errors in the stage movement, the pitch component may be nonlinearly defined.

In this case, it is preferred that information on the pitch component be held linked with each light beam locus. However, when only position deviation or the inclination of the substrate is taken into account, the same pitch component (in this case, also the pitch width may be constant) may be allotted to all the light beam loci.

That is, correction of the position of the substrate and correction of the deformation of the image in a direction perpendicular to the direction of the substrate conveyance can be dealt with by a change of the light beam locus, and correction of the deformation of the image in a direction of the substrate conveyance can be dealt with by a change of the pitch component. In this case, by giving a pitch component for each light beam locus, even correction of the deformation where the deformation is local or changes continuously can be dealt with.

The pitch component may be set along the direction of the light beam locus vector, or along the direction of the vector obtained by projecting the light beam locus vector onto a predetermined coordinate axis.

The group of pieces of information on the intersections along the light beam locus may be handled like compressed data by obtaining information on the positions of intersections of the contour of the image and the light beam locus linked with the pitch component (e.g., by giving the positions of intersections with the pitch component).

In the embodiments described above, a single exposing light spot data locus may be obtained for each group of two or more micromirrors (beams). For example, an exposing light spot data locus may be obtained for each group of a plurality of beams, which are focused by a single micro lens of the micro lens array.

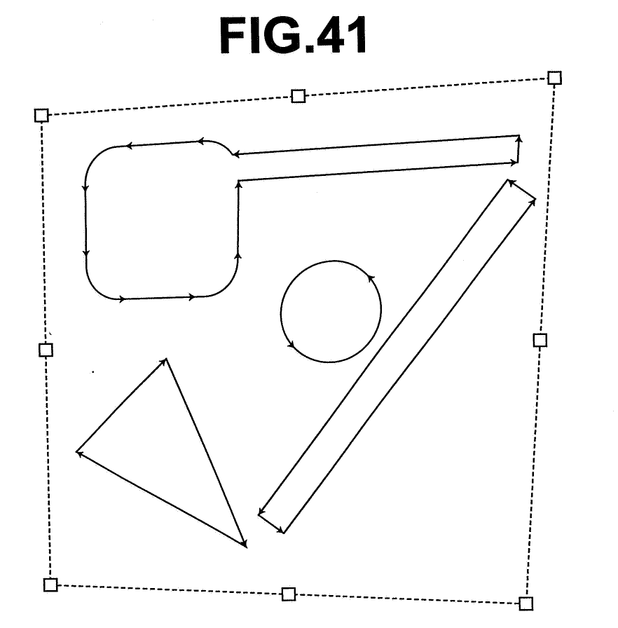

In the case that deformation of the substrate is to be compensated for by deforming the image data, the contour vectors may be deformed, as illustrated in FIG. 41. In this case, the detected positional information of the reference marks 12a are provided to the intermediate vector generating means 50 from the detected positional information obtaining means 52 of FIG. 5.

As described above, the exposing light spot data is obtained based on the lines (exposing light spot data loci), which are defined on the vector format image data. Therefore, the calculations involved in the obtainment of the exposing light spot data can be performed at high speed. There are differences between the calculations which are performed in the case that the exposing light locus vector, based on the exposing light locus data, is employed as the line and in the case that a beam row vector, defined along a row of beam spots, is employed as the line. In the case that the exposing light locus vector is employed, the number of calculations of intersections is the number of micromirrors (e.g., 1024×240) multiplied by the number of vectors in the exposure image data. In the case that the beam row vector is employed, the number of calculations of intersections is the number of beam rows (for example, 240)×the number of vectors of the exposure image data multiplied by the number of frames. In this case, the number of frames is determined by the length of the substrate/exposure pitch, and is a value of 1,000,000, for example. Accordingly, the case that the beam row vectors are employed results in a greater amount of calculations. However, in the case that the beam row vectors are employed, data can be generated for each frame, which is superior from a real time processing standpoint. That is, non-reproducible deviations, such as those caused by vibration of the stage, can also be dealt with (the same applies to cases in which the predetermined region A is set with respect to the DMD 36, as in the example of FIG. 39).

1.-83. (canceled)

84. A method of obtaining drawing-spot data, wherein the drawing-spot data is data to be used when an image is drawn on a drawing object by forming, based on the drawing-spot data, drawing-spots on the drawing object, the method comprising the steps of:
obtaining original vector format image data of the image;
obtaining the coordinates of positions on the image data corresponding to positions at which the drawing-spots are to be formed on the drawing object; and
obtaining the drawing-spot data of the drawing-spots based on the vector format image data and the coordinates of the positions.

85. A method of obtaining drawing-spot data, wherein the drawing-spot data is data to be used when an image is drawn on a drawing object by moving a drawing-spot forming region in which drawing-spots are formed based on the drawing-spot data relative to the drawing object and by sequentially forming the drawing-spots on the drawing object based on the movement of the drawing-spot forming region, the method comprising the steps of:
obtaining original vector format image data of the image;
obtaining drawing track information about the drawing-spot forming region on the drawing object or in image space above the drawing object, the information being information for drawing the image;
obtaining intersection arrangement information representing the arrangement of intersections of the contour of an image represented by the image data or derivable from the image data with a drawing-spot data track on the image data corresponding to the drawing track information; and
obtaining the drawing-spot data corresponding to the drawing-spot data track based on the intersection arrangement information.

86. A method of drawing, wherein an image is drawn on a drawing object by forming drawing-spots on the drawing object based on drawing-spot data, the method comprising the steps of:
obtaining original vector format image data of the image;
obtaining the coordinates of positions on the image data corresponding to positions at which the drawing-spots are to be formed on the drawing object;
obtaining the drawing-spot data of the drawing-spots based on the vector format image data and the coordinates of the positions; and
forming the drawing-spots on the drawing object based on the obtained drawing-spot data.

87. A method of drawing, as defined in claim 86, further comprising the step of:
superposing an image area determined based on the image data and the coordinates of the positions one on the other, wherein the drawing-spot data is obtained based on image data of the image area to which the coordinates of the positions belong.

88. A method of drawing, as defined in claim 87, wherein an image is drawn on the drawing object by moving a drawing-spot forming region in which drawing-spots are formed based on the drawing-spot data relative to the drawing object and by sequentially forming the drawing-spots on the drawing object based on the movement of the drawing-spot forming region, and wherein the coordinates of the positions correspond to the drawing-spot forming region at a predetermined position on the drawing object.

89. A method of drawing, as defined in claim 86, further comprising the step of:
superposing an image area determined based on the image data and a line including the coordinates of the positions one on the other, wherein the drawing-spot data is obtained based on image data of the image area that is overlaid with the line.

90. A method of drawing, as defined in claim 89, wherein the drawing-spot data is obtained based on a position at which the image area determined based on the image data and the line intersect.

91. A method of drawing, as defined in claim 89, further comprising the step of:
obtaining intersection arrangement information representing intersections of the line and the contour of an image represented by the image data or derivable from the image data, wherein the drawing-spot data is obtained based on the intersection arrangement information.

92. A method of drawing, as defined in claim 89, wherein the line connects the coordinates of a plurality of positions that correspond to a plurality of drawing-spots.

93. A method of drawing, as defined in claim 89, wherein the line connects the coordinates of a plurality of positions that correspond to a plurality of drawing-spots arranged in time series.

94. A method of drawing, as defined in claim 89, wherein an image is drawn on the drawing object by moving a drawing-spot forming region in which drawing-spots are formed based on the drawing-spot data relative to the drawing object and by sequentially forming the drawing-spots on the drawing object based on the movement of the drawing-spot forming region, and wherein the line connects the coordinates of a plurality of positions that correspond to a plurality of drawing-spots arranged in time series.

95. A method of drawing, as defined in claim 89, wherein an image is drawn on the drawing object by moving a drawing-spot forming region in which drawing-spots are formed based on the drawing-spot data relative to the drawing object and by sequentially forming the drawing-spots on the drawing object based on the movement of the drawing-spot forming region, and wherein the line is a drawing track of the drawing-spot forming region on the drawing object or in image space above the drawing object.

96. A method of drawing, as defined in claim 89, wherein an image is drawn on the drawing object by moving a drawing-spot forming region group including a plurality of drawing-spot forming regions in which drawing-spots are formed based on the drawing-spot data relative to the drawing object and by sequentially forming a drawing-spot group corresponding to the drawing-spot forming region group on the drawing object based on the movement of the drawing-spot forming region group, and wherein the line corresponds to a line connecting at least a portion of the drawing-spot forming regions of the drawing-spot forming region group at a predetermined position on the drawing object.

97. A method of drawing, as defined in claim 89, wherein the line is accompanied by information about sampling pitch.

98. A method of drawing, as defined in claim 86, further comprising the step of:
superposing an image area determined based on the image data and a predetermined area including the coordinates of the positions one on the other, wherein the drawing-spot data is obtained based on image data of the image area that is overlaid with the predetermined area.

99. A method of drawing, as defined in claim 98, wherein an image is drawn on the drawing object by moving a drawing-spot forming region group including a plurality of drawing-spot forming regions in which drawing-spots are formed based on the drawing-spot data relative to the drawing object and by sequentially forming a drawing-spot group corresponding to the drawing-spot forming region group on the drawing object based on the movement of the drawing-spot forming region group, and wherein the predetermined area corresponds to at least a portion of the regions of the drawing-spot forming region group at a predetermined position on the drawing object.

100. A method of drawing, wherein an image is drawn on a drawing object by moving a drawing-spot forming region in which drawing-spots are formed based on drawing-spot data relative to the drawing object and by sequentially forming the drawing-spots on the drawing object based on the movement of the drawing-spot forming region, the method comprising the steps of:
obtaining original vector format image data of the image;
obtaining drawing track information about the drawing-spot forming region on the drawing object, the drawing track being a track to be taken during drawing of the image;
obtaining intersection arrangement information representing the arrangement of intersections of the contour of an image represented by the image data or derivable from the image data with the drawing-spot data track on the image data corresponding to the drawing track information;
obtaining drawing-spot data corresponding to the drawing-spot data track based on the intersection arrangement information; and
forming the drawing-spots on the drawing object by forming the drawing-spot forming region based on the obtained drawing-spot data.

101. A method of drawing, as defined in claim 100, wherein the drawing-spot data track is divided by intersections represented by the intersection arrangement information into segmental drawing-spot data tracks, and wherein binary data is alternately allocated to the segmental drawing-spot data tracks in the order of arrangement of the segmental drawing-spot data tracks, and wherein the binary data allocated to each of the segmental drawing-spot data tracks is sampled at a predetermined interval in a scanning direction on the image data corresponding to the direction of the movement to obtain the drawing-spot data corresponding to the drawing-spot data track.

102. A method of drawing, as defined in claim 100, wherein the values of the coordinates of the intersection arrangement information in a scanning direction on the image data corresponding to the direction of the movement are obtained, and wherein each of the obtained values of the coordinates is divided by the value of a predetermined interval in the scanning direction on the image data to obtain quantized values, and wherein a difference between quantized values adjacent to each other in the scanning direction on the image data is obtained as run length data, and wherein the drawing-spot data corresponding to the drawing-spot data track is obtained by decoding the obtained run length data.

103. A method of drawing, as defined in claim 100, wherein speed fluctuation information representing a fluctuation in actual movement speed of the drawing object during drawing of the image with respect to predetermined relative movement speed of the drawing object that has been set in advance is obtained, and wherein the drawing-spot data is obtained so that the number of sets of drawing-spot data increases in a drawing area where the actual movement speed of the drawing object is relatively slow based on the obtained speed fluctuation information.

104. A method of drawing, as defined in claim 100, wherein a plurality of reference marks provided in advance at predetermined positions on the drawing object are detected to obtain detecting position information representing the positions of the reference marks, and wherein the drawing track information is obtained based on the obtained detecting position information.

105. A method of drawing, as defined in claim 100, wherein information about a deviation of an actual movement direction of the drawing object during drawing of the image from a predetermined relative movement direction of the drawing object is obtained, and wherein the drawing track information is obtained based on the obtained information about the deviation.

106. A method of drawing, as defined in claim 104, wherein information about a deviation of an actual movement direction of the drawing object during drawing of the image from a predetermined relative movement direction of the drawing object is obtained, and wherein the drawing track information is obtained based on the obtained information about the deviation and the detecting position information.

107. An apparatus for obtaining drawing-spot data, wherein the drawing-spot data is data to be used when an image is drawn on a drawing object by forming, based on the drawing-spot data, drawing-spots on the drawing object, the apparatus comprising:
a position coordinate obtaining means for obtaining the coordinates of positions on original vector format image data of the image corresponding to positions at which the drawing-spots should be formed on the drawing object; and
a drawing-spot data obtaining means for obtaining the original vector format image data of the image and for obtaining the drawing-spot data of the drawing-spots based on the obtained original vector format image data and the coordinates of the positions obtained by the position coordinate obtaining means.

108. An apparatus for obtaining drawing-spot data, wherein the drawing-spot data is data to be used when an image is drawn on a drawing object by moving a drawing-spot forming region in which drawing-spots are formed based on the drawing-spot data relative to the drawing object and by sequentially forming the drawing-spots on the drawing object based on the movement of the drawing-spot forming region, the apparatus comprising:
a drawing track information obtaining means for obtaining drawing track information representing a drawing track of the drawing-spot forming region on the drawing object or in image space above the drawing object, the information being information for drawing the image;
an intersection arrangement information obtaining means for obtaining original vector format image data of the image and for obtaining intersection arrangement information representing the arrangement of intersections of the contour of an image represented by the obtained image data or derivable from the image data with the drawing-spot data track on the image data corresponding to the drawing track information; and
a drawing-spot data obtaining means for obtaining the drawing-spot data corresponding to the drawing track based on the intersection arrangement information obtained by the intersection arrangement information obtaining means.

109. An apparatus for drawing, wherein an image is drawn on a drawing object by forming, based on drawing-spot data, drawing-spots on the drawing object, the apparatus comprising:
a position coordinate obtaining means for obtaining the coordinates of positions on original vector format image data of the image corresponding to positions at which the drawing-spots should be formed on the drawing object;
a drawing-spot data obtaining means for obtaining the original vector format image data of the image and for obtaining the drawing-spot data of the drawing-spots based on the obtained vector format image data and the coordinates of the positions obtained by the position coordinate obtaining means; and
a drawing means for forming the drawing-spots on the drawing object based on the drawing-spot data obtained by the drawing-spot data obtaining means.

110. An apparatus for drawing, as defined in claim 109, wherein the drawing-spot data obtaining means superposes an image area determined based on the image data and the coordinates of the positions one on the other and obtains the drawing-spot data based on image data of the image area to which the coordinates of the position belong.

111. An apparatus for drawing, as defined in claim 110, wherein an image is drawn on the drawing object by moving a drawing-spot forming region in which drawing-spots are formed based on drawing-spot data relative to the drawing object and by sequentially forming the drawing-spots on the drawing object based on the movement of the drawing-spot forming region, and wherein the coordinates of the positions correspond to the drawing-spot forming region at a predetermined position on the drawing object.

112. An apparatus for drawing, as defined in claim 109, wherein the drawing-spot data obtaining means superposes an image area determined based on the image data and a line including the coordinates of the positions one on the other and obtains the drawing-spot data based on image data of the image area that is overlaid with the line.

113. An apparatus for drawing, as defined in claim 112, wherein the drawing-spot data obtaining means obtains the drawing-spot data based on a position at which the image data and the line intersect.

114. An apparatus for drawing, as defined in claim 112, further comprising an intersection arrangement information obtaining means for obtaining intersection arrangement information representing intersections of the line and the contour of an image represented by the image data or derivable from the image data, wherein the drawing-spot data obtaining means obtains the drawing-spot data based on the intersection arrangement information obtained by the intersection arrangement information obtaining means.

115. An apparatus for drawing, as defined in claim 112, wherein the line connects the coordinates of a plurality of positions that correspond to a plurality of drawing-spots.

116. An apparatus for drawing, as defined in claim 112, wherein the line connects the coordinates of a plurality of positions that correspond to a plurality of drawing-spots arranged in time series.

117. An apparatus for drawing, as defined in claim 112, wherein the drawing-spot data is data to be used when an image is drawn on the drawing object by moving a drawing-spot forming region in which drawing-spots are formed based on the drawing-spot data relative to the drawing object and by sequentially forming the drawing-spots on the drawing object based on the movement of the drawing-spot forming region, and wherein the line connects the coordinates of a plurality of positions that correspond to a plurality of drawing-spots arranged in time series.

118. An apparatus for drawing, as defined in claim 112, wherein an image is drawn on the drawing object by moving a drawing-spot forming region in which drawing-spots are formed based on drawing-spot data relative to the drawing object and by sequentially forming the drawing-spots on the drawing object based on the movement of the drawing-spot forming region, and wherein the line corresponds to a drawing track of the drawing-spot forming region on the drawing object or in image space above the drawing object.

119. An apparatus for drawing, as defined in claim 112, wherein an image is drawn on the drawing object by moving a drawing-spot forming region group including a plurality of drawing-spot forming regions in which drawing-spots are formed based on drawing-spot data relative to the drawing object and by sequentially forming a drawing-spot group corresponding to the drawing-spot forming region group on the drawing object based on the movement of the drawing-spot forming region group, and wherein the line corresponds to a line connecting at least a portion of the drawing-spot forming regions of the drawing-spot forming region group at a predetermined position on the drawing object.

120. An apparatus for drawing, as defined in claim 112, wherein the line is accompanied by information about sampling pitch.

121. An apparatus for drawing, as defined in claim 109, wherein the drawing-spot data obtainment means superposes an image area determined based on the image data and a predetermined area including the coordinates of the positions one on the other and obtains the drawing-spot data based on image data of the image area that is overlaid with the predetermined area.

122. An apparatus for drawing, as defined in claim 121, wherein an image is drawn on the drawing object by moving a drawing-spot forming region group including a plurality of drawing-spot forming regions in which drawing-spots are formed based on the drawing-spot data relative to the drawing object and by sequentially forming a drawing-spot group corresponding to the drawing-spot forming region group on the drawing object based on the movement of the drawing-spot forming region group, and wherein the predetermined area corresponds to at least a portion of the regions of the drawing-spot forming region group at a predetermined position on the drawing object.

123. An apparatus for drawing, wherein an image is drawn on a drawing object by moving a drawing-spot forming region in which drawing-spots are formed based on drawing-spot data relative to the drawing object and by sequentially forming the drawing-spots on the drawing object based on the movement of the drawing-spot forming region, the apparatus comprising:
a drawing track information obtaining means for obtaining drawing track information about a drawing track of the drawing-spot forming region on the drawing object for drawing the image;
an intersection arrangement information obtaining means for obtaining original vector format image data of the image and for obtaining intersection arrangement information representing the arrangement of intersections of the contour of an image represented by the image data or derivable from the obtained image data with a drawing-spot data track on the drawing object corresponding to the drawing track information;
a drawing-spot data obtaining means for obtaining, based on the intersection arrangement information obtained by the intersection arrangement information obtaining means, a plurality of sets of drawing-spot data corresponding to the drawing track; and
a drawing means for forming, based on the drawing-spot data obtained by the drawing-spot data obtaining means, the drawing-spots on the drawing object by forming the drawing-spot forming region.

124. An apparatus for drawing, as defined in claim 123, wherein the drawing-spot data obtaining means obtains the drawing-spot data corresponding to the drawing-spot data track by dividing the drawing-spot data track by intersections represented by the intersection arrangement information into segmental drawing-spot data tracks, by allocating binary data alternately to the segmental drawing-spot data tracks in the order of the arrangement of the segmental drawing-spot data tracks and by sampling the binary data allocated to each of the segmental drawing-spot data tracks at a predetermined interval in a scanning direction on the image data corresponding to the direction of the movement.

125. An apparatus for drawing, as defined in claim 123, wherein the drawing-spot data obtaining means obtains the drawing-spot data corresponding to the drawing-spot data track by obtaining the coordinate values of the intersection arrangement information in a scanning direction on the image data corresponding to the direction of the movement, by obtaining quantized values by dividing each of the obtained coordinate values by the value of a predetermined interval in the scanning direction on the image data, by obtaining a difference between quantized values adjacent to each other in the scanning direction on the image data as run length data, and by decoding the obtained run length data.

126. An apparatus for drawing, as defined in claim 123, further comprising:
a speed fluctuation information obtaining means for obtaining speed fluctuation information representing a fluctuation in actual movement speed of the drawing object during drawing of the image with respect to predetermined relative movement speed of the drawing object, wherein the drawing-spot data obtainment means obtains the drawing-spot data so that the number of sets of the drawing-spot data increases in a drawing region in which the actual movement speed of the drawing object is relatively slow based on the speed fluctuation information obtained by the speed fluctuation information obtainment means.

127. An apparatus for drawing, as defined in claim 123, further comprising:
a position information detecting means for obtaining detecting position information representing the positions of a plurality of reference marks by detecting the plurality of reference marks that have been provided in advance at predetermined positions on the drawing object, wherein the drawing track information obtaining means obtains the drawing track information based on the detecting position information obtained by the position information detecting means.

128. An apparatus for drawing, as defined in claim 123, further comprising:
a deviation information obtaining means for obtaining information about a deviation of an actual movement direction of the drawing object during drawing of the image from a predetermined relative movement direction of the drawing object, wherein the drawing-spot track information obtainment means obtains the drawing-spot track information based on the information about the deviation obtained by the deviation information obtaining means.

129. An apparatus for drawing, as defined in claim 127, further comprising:
a deviation information obtaining means for obtaining information about a deviation of an actual movement direction of the drawing object during drawing of the image from a predetermined relative movement direction of the drawing object, wherein the drawing-spot track information obtainment means obtains the drawing track information based on the information about the deviation obtained by the deviation information obtaining means and the detecting position information obtained by the position information detecting means.
